(19) United States
(12) Patent Application Publication
(10) Pub. No.: US 2025/0340682 A1
(43) Pub. Date: Nov. 6, 2025

(54) POLYETHYLENE COMPOSITIONS AND PROCESSES FOR THEIR PRODUCTION

(71) Applicant: ExxonMobil Chemical Patents Inc., Spring, TX (US)

(72) Inventors: Rhutesh K. SHAH, Katy, TX (US); Michael J. VINCK, Lebbeke (BE)

(21) Appl. No.: 18/866,216

(22) PCT Filed: Mar. 28, 2023
(86) PCT No.: PCT/US2023/065033

§ 371 Date: Nov. 15, 2024

Related U.S. Application Data
(60) Provisional application No. 63/364,923, filed on May 18, 2022.

(51) Int. Cl. C08F 10/14; C08F 10/04; C08F 10/08

(52) U.S. Cl. CPC C08F 10/14; C08F 10/04; C08F 10/08

(57) ABSTRACT

Provided are polyethylene copolymers with an improved balance of melt strength and processability and methods for making such polyethylene copolymers. In some embodiments, the polyethylene copolymers include from 9 to 11 weight percent of at least one comonomer having 4 to 8 carbon atoms, and have a density in the range of from 0.908 to 0.916 g/cm³, a melt index I₂ in the range of 0.10 to 0.60 g/10 min., and a melt index ratio I₂₁/I₂ greater than or equal to 46.9−(33.3×(I₂)), wherein I₂ is provided in g/10 min. In some embodiments, the polyethylene copolymer is produced in a dry mode gas phase process using a metallocene catalyst.

### CROSS-REFERENCE TO RELATED CASES

This application claims the benefit of U.S. Provisional Application No. 63/364,923, filed May 18, 2022, entitled “Polyethylene Compositions And Processes For Their Production”, the entirety of which is incorporated by reference herein.

### FIELD OF THE INVENTION

This disclosure relates to polyethylene copolymers, polymerization processes for making such polyethylene copolymers, and products including such polyethylene copolymers.

### BACKGROUND OF THE INVENTION

Low melt index, high molecular weight polymers are typically used in applications such as stretch hoods, greenhouse films, and construction liners, since they possess the necessary melt strength to support the large melt bubble formed during blown film processing. Lower density metallocene-based linear low density polyethylene (“mLLDPE”) resins offer superior toughness and optical properties for such applications as compared to current alternatives. However, current low melt index, high molecular weight mLLDPE resins possess high melt viscosity, which could impose processability limits due to high melt viscosities in addition to producing high pressures and high motor loads in extruders. It would be desirable to have low density, high molecular weight mLLDPE resins having high toughness and transparency that also have lower melt viscosities, allowing improved processibility and reduced production costs via lower extruder pressures and a corresponding reduction in motor loads.

WO publication WO2021/221904 discloses polyethylene copolymers having density of 0.931 to 0.936 g/cm³ that exhibit improved stress crack resistance, methods for making such copolymers using a metallocene catalyst, and films made from such copolymers. The polyethylene copolymers include at least 95 wt. % ethylene and at most 5 wt. % of at least one comonomer having 3 to 18 carbon atoms and have a 30% single point notched constant tensile load of at least 1,000 hours. It is suggested therein that reducing the concentration of induced condensing agents can lead to an increase in the amount of comonomer incorporated into higher molecular weight polymer chains, resulting in a desirable balance of properties.

A recent article discloses mLLDPE resins having a density of 0.911 to 0.912 g/cm³ and a fractional melt index produced using a metallocene catalyst. The article states that the mLLDPE resins exhibit excellent dart impact, puncture toughness, high clarity, low seal initiation temperature, and good softness useful in a number of blown film applications. The article suggests that improved performance of the mLLDPE resins results from a small amount of long-chain branching. See “Novel metallocene-based linear low density polyethylene (LLDPE) for blown film applications,” IP.com Prior Art Database Technical Disclosure, IP.com pub. no.: IPCOM000266833D, IP.com e-pub. date: Aug. 25, 2021.

Another recent article discloses the use of induced condensing agents to control rheology and melt strength of ethylene-butene mLLDPEs having a density of 0.910 to 0.960 g/cm³, suggesting that increasing induced condensing agents in the range of 10 mol % to 18 mol % during gas phase polymerization results in improved melt strength. Increasing the concentration of induced condensing agents during polymerization also produced resins having a higher comonomer content in lower molecular weight polymer chains relative to the comonomer content in higher molecular weight polymer chains. See “Induced Condensing Agent Control for Tunable Linear Low Density Polyethylene Properties during Gas Phase Polymerization with Transition Metal Catalyst Systems,” IP.com Prior Art Database Technical Disclosure, IP.com Number: IPCOM000268060D, IP.com e-pub. date: Dec. 20, 2021.

A need still exists for low density, high molecular weight polyethylenes having a balance of melt strength, processability, toughness, and transparency suited for production of certain products utilizing a blown film process. A valuable approach to producing such polymers would avoid expensive additives and performance tradeoffs. Ideally, improved mLLDPE compositions could be made using economical starting materials, commonly used equipment, and familiar techniques.

### SUMMARY OF THE INVENTION

The present disclosure provides a polyethylene copolymer comprising units derived from ethylene and at least one olefin comonomer having 4 to 8 carbon atoms and having an improved balance of melt strength and processability.

In some embodiments, the polyethylene copolymer has:
a) a density in the range of from 0.908 g/cm& to 0.916 g/cm³;
b) a melt index I₂ in the range of from 0.10 g/10 min to 0.60 g/10 min.; and
c) a melt index ratio I₂₁/I₂ of greater than or equal to 46.9−(33.3×(I₂)), wherein I₂ is provided in g/10 min.

In some embodiments, in addition to the foregoing attributes, the polyethylene copolymer has a comonomer content in the range of from 9.0 wt. % to 11.0 wt. %.

In some embodiments, the comonomer is 1-hexene, and the polyethylene copolymer has a melt index I₂ in the range of 0.10 g/i) min. to 0.30 g/10 min. and a melt index ratio I₂₁/I₂ (“MIR”) of greater than or equal to 45.1, or a melt index 12 in the range of 0.40 g/10 min. to 0.60 g/10 min, and a melt index ratio I₂₁/I₂ of greater than or equal to 35.1.

In some embodiments, the polyethylene copolymer is produced in a continuous gas phase process comprising:
a) continuously passing a gaseous stream, comprising ethylene and at least one olefin comonomer having from 4 to 8 carbon atoms, through a fluidized bed reactor in the presence of a metallocene catalyst under polymerization conditions, wherein polymerization conditions comprise an ethylene partial pressure greater than or equal to 1300 kPaa and a reactor pressure of less than or equal to 10,000 kPag;
b) withdrawing the polyethylene copolymer and a stream comprising unreacted ethylene, unreacted comonomer, and optionally an induced condensing agent, wherein the induced condensing agent comprises less than 5 mol % of the stream;
c) cooling the stream, comprising unreacted ethylene, unreacted comonomer, and induced condensing agent, to form a cooled stream, wherein the cooled stream is substantially free of a liquid phase; and
d) feeding the cooled stream to the fluidized bed reactor with sufficient additional ethylene and at least one comonomer to replace the ethylene and the at least one comonomer polymerized and withdrawn as the polyethylene copolymer.

The foregoing has outlined rather broadly the features and technical advantages of the present invention in order that the detailed description of the invention that follows may be better understood. Additional features and advantages of the invention will be described hereinafter, which form the subject matter of the claims of the invention. It should be appreciated by those skilled in the art that the conception and specific embodiments disclosed may be readily utilized as a basis for modifying or designing film structures and/or other processes for carrying out the same purposes of the present invention. It should also be realized by those skilled in the art that such equivalent constructions do not depart from the spirit and scope of the invention as set forth in the appended claims. The novel features which are believed to be characteristic of the invention, both as to its structure and method of manufacture, together with further objects and advantages will be better understood from the following description.

### BRIEF DESCRIPTION OF THE DRAWINGS

The claimed subject matter may be understood by reference to the following description taken in conjunction with the accompanying drawings, in which like reference numerals identify like elements, and in which:

FIG. 1 is an overlaid graph of weight fraction vs. molecular weight for polyethylene copolymers having a melt index I₂ of about 0.2 g/10 min. in accordance with embodiments of the present techniques compared to currently available copolymers;

FIG. 2 is an overlaid graph of weight fraction vs molecular weight for polyethylene copolymers having a melt index I₂ of about 0.5 g/10 min. in accordance with embodiments of the present techniques compared to currently available copolymers;

FIG. 3 is an overlaid graph of comonomer content vs. molecular weight for polyethylene copolymers having a melt index I₂ of about 0.2 g/10 min. in accordance with embodiments of the present techniques compared to currently available copolymers;

FIG. 4 is an overlaid graph of comonomer content vs. molecular weight for polyethylene copolymers having a melt index I₂ of about 0.5 g/10 min. in accordance with embodiments of the present techniques compared to currently available copolymers;

FIG. 5 is an overlaid graph of branching index vs. molecular weight for polyethylene copolymers having a melt index I₂ of about 0.2 g/10 min. in accordance with embodiments of the present techniques compared to currently available copolymers;

FIG. 6 is an overlaid graph of branching index vs. molecular weight for polyethylene copolymers having a melt index I₂ of about 0.5 g/10 min. in accordance with embodiments of the present techniques compared to currently available copolymers;

FIG. 7 is an overlaid graph of phase angle vs. complex modulus for polyethylene copolymers having a melt index I₂ of about 0.2 g/10 min. in accordance with embodiments of the present techniques compared to currently available copolymers; and

FIG. 8 is an overlaid graph of phase angle vs. complex modulus for polyethylene copolymers having a melt index I₂ of about 0.5 g/10 min. in accordance with embodiments of the present techniques compared to currently available copolymers.

While the disclosed process and system are susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the subject matter claimed below will now be disclosed. In the interest of clarity, some features of some actual implementations may not be described in this specification. It will be appreciated that in the development of any such actual embodiments, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

### Definitions

“Cn” as used herein, and unless otherwise specified, the term means hydrocarbon(s) having n carbon atom(s) per molecule, wherein n is a positive integer.

“Free of” a component, as used herein, refers to a composition substantially devoid of the component, or comprising the component in an amount of less than about 0.01 wt %, by weight of the total composition.

“Olefin,” as used herein, and alternatively referred to as “alkene,” is a linear, branched, or cyclic compound of carbon and hydrogen having at least one double bond. For purposes of this specification and the claims appended thereto, when a polymer or copolymer is referred to as “comprising” an olefin, the olefin present in such polymer or copolymer is the polymerized form of the olefin. For example, when a copolymer is described as having an “ethylene” content of 35 wt. % to 55 wt. %, it is understood that the mer unit in the copolymer is derived from ethylene in the polymerization reaction and the derived units are present at 35 wt. % to 55 wt. %, based upon the weight of the copolymer.

“Polyethylene copolymer,” as used herein, means a polymer or copolymer comprising at least 89 wt. % ethylene. The terms “polyethylene polymer,” “polyethylene,” “ethylene polymer,” “ethylene copolymer,” and “ethylene-based polymer” have the same meaning as polyethylene copolymer, except where otherwise indicated (e.g. where a polyethylene homopolymer is referred to, this means a polymer formed from ethylene monomer without comonomer units, e.g., 100 wt % ethylene-derived units).

“Polymerization conditions,” as used herein, means conditions conducive to the reaction of one or more olefin monomers when contacted with an activated olefin polymerization catalyst to produce a polyolefin polymer, including a skilled artisan's selection of temperature, pressure, reactant concentrations, optional solvent/diluents, reactant mixing/addition parameters, and other conditions within at least one polymerization reactor.

For the sake of brevity, only certain ranges are explicitly disclosed herein. However, in addition to recited ranges, any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

### Polyethylene Copolymers

Polyethylene copolymers provided herein comprise or consist of units derived from ethylene and at least one olefin comonomer having from 4 to 8 carbon atoms and have a density in the range of from 0.908 g/cm³ to 0.916 g/cm³, a melt index I₂ in the range of from 0.10 g/10 min. to 0.60 g/10 min., a melt index ratio I₂₁/I₂ of greater than or equal to 46.9−(33.3×(I₂)) (wherein I₂ is provided in g/10 min.), and a branching index g′ᵥᵢₛ (LCB Index, also referred to as g′(vis) or g′ index) in the range of from 0.940 to 0.960, reflecting a measurable, albeit minor, degree of long-chain branching. The polyethylene copolymers described herein have an improved balance of melt strength, processability (e.g., reduced melt viscosity), toughness, and transparency suited for production certain products utilizing a blown film process.

The polyethylene copolymer can have a melt index ratio I₂₁/I₂ of greater than or equal to 51.8−(33.3×(I₂)), 52.8−(33.3×(I₂)), or greater than or equal to 55.1−(33.3×(I₂)), wherein 12 is provided in g/10 min.

The polyethylene copolymer can have a comonomer content in the range of from 9.0 wt % to 11.0 wt. %. In some embodiments, the comonomer is selected from butene, hexene, or a combination thereof. In some embodiments, the comonomer is 1-butene. In some embodiments, the comonomer is 1-hexene.

The density of the polyethylene copolymer can be in the range of ((0.0025×W)+(0.0056×*I₂)+0.9353) g/cm³±0.001 g/cm³, wherein W is the weight percent comonomer incorporated into the polyethylene copolymer and I₂ is provided in g/10 min. In various embodiments, the polyethylene copolymer has a melt index I₂ in the range of from 0.10 g/10 min. to 0.30 g/10 min. and a density in the range of from 0.908 g/cm³ to 0.915 g/cm³. 0.909 g/cm³ to 0.914 g/cm³. or 0.910 g/cm³ to 0.913 g/cm³. In some embodiments, the polyethylene copolymer has a melt index I₂ in the range of from 0.40 g/10 min. to 0.60 g/10 min. and a density in the range of from 0.910 g/cm³, to 0.916 g/cm³, 0.911 g/cm³ to 0.915 g/cm³, or 0.912 g/cm³ to 0.914 g/cm³.

The polyethylene copolymer can have a weight average molecular weight M_{w} in the range of ((2,900×W)−(63,500×I₂)+110,300) g/mol±1,000 g/mol, +2,000 g/mol, or ±5,000 g/mol, wherein W is the weight percent comonomer incorporated into the polyethylene copolymer and I₂ is provided in g/10 min. In some embodiments, the polyethylene copolymer has a melt index I₂ in the range of 0.10 g/10 min. to 0.30 g/10 min. and a weight average molecular weight M_{w} in the range of 117,400 g/mol to 135,900 g/mol, 120,300 g/mol to 133,000 g/mol, 120,600 g/mol to 132,700 g/mol, or 123,200 g/mol to 130,100 g/mol. In some embodiments, the polyethylene copolymer has a melt index I₂ in the range of 0.40 g/10 min. to 0.60 g/10 min. and a weight average molecular weight M_{w} in the range of 98,300 g/mol to 116,800 g/mol, 101,200 g/mol to 133,900 g/mol, 101,500 g/mol to 113,700 g/mol, or 104,100 g/mol to 111,000 g/mol.

The polyethylene copolymer can have a Z-average molecular weight M_{z} in the range of ((2,360×W)−(125,900×I₂)+252,000) g/mol±500 g/mol, ±1000 g/mol, or ±2,500 g/mol, wherein W is the weight percent comonomer incorporated into the polyethylene copolymer and I₂ is provided in g/10 min. In some embodiments, the polyethylene copolymer has a melt index I₂ in the range of 0.10 g/10 min. to 0.30 g/10 min. and a Z-average molecular weight M_{z} in the range of 235,000 g/mol to 265,000 g/mol, 238,000 g/mol to 263,000 g/mol, 240,000 g/mol to 261,000 g/mol, or 242,000 g/mol to 259,000 g/mol. In some embodiments, the polyethylene copolymer has a melt index I₂ in the range of 0.40 g/10 min. to 0.60 g/10 min. and a Z-average molecular weight M_{z} in the range of 197,500 g/mol to 227,000 g/mol, 200,000 g/mol to 225,000 g/mol, 202,000 g/mol to 223,000 g/mol, or 204,000 g/mol to 221,100 g/mol.

The polyethylene copolymer can have a number average molecular weight Mₙ in the range of ((1,027×W)−(18,620×I₂)+31,500) g/mol±250 g/mol, ±500 g/mol, or ±1,250 g/mol, wherein W is the weight percent comonomer incorporated into the polyethylene copolymer and I₂ is provided in g/10 min. In some embodiments, the polyethylene copolymer has a melt index I₂ in the range of 0.10 g/10 min. to 0.30 g/10 min. and a number average molecular weight Mₙ in the range of 35,200 g/mol to 41,000 g/mol, 36,100 g/mol to 40,000 g/mol, 36,200 g/mol to 39,900 g/mol, or 37,000 g/mol to 39,100 g/mol. In some embodiments, the polyethylene copolymer has a melt index I₂ in the range of 0.40 g/10 min. to 0.60 g/10 min. and a number average molecular weight Mₙ in the range of 29,600 g/mol to 35,400 g/mol, 30,500 g/mol to 34,400 g/mol, 30,600 g/mol to 34,300 g/mol, or 31,500 g/mol to 33,500 g/mol.

The polyethylene copolymer can have a molecular weight distribution M_{w}/Mₙ in the range of from 3.27 to 3.46, a molecular weight distribution M_{z}/M_{w} less than or equal to 2.0, and/or a molecular weight distribution M_{z}/Mₙ in the range of from 6.42 to 6.95. In some embodiments, the polyethylene copolymer has a melt index 12 in the range of 0.10 g/10 min. to 0.30 g/10 min. and a molecular weight distribution M_{w}/Mₙ in the range of from 3.27 to 3.46, a molecular weight distribution M_{z}/M_{w} less than or equal to 2.0, and/or a molecular weight distribution M_{z}/Mₙ in the range of from 6.42 to 6.95. In some embodiments, the polyethylene copolymer has a melt index I₂ in the range of 0.40 g/10 min. to 0.60 g/10 min. and a molecular weight distribution M_{w}/Mₙ in the range of from 3.27 to 3.46, a molecular weight distribution M_{z}/M_{w} less than or equal to 2.0, and/or a molecular weight distribution M_{z}/Mₙ in the range of from 6.42 to 6.95.

The polyethylene copolymer can exhibit visual properties according to one or both of the following:
a gloss at 45° of greater than or equal to (33.67+(46.67×(I₂))) GU, greater than or equal to (38.67+(46.67×(I₂))) GU, or greater than or equal to (43.67+(46.67×(I₂))) GU, wherein I₂ is provided in g/10 min. In some embodiments, the polyethylene copolymer has a melt index I₂ in the range of 0.10 g/10 min. to 0.30 g/10 min. and a gloss at 450 of greater than or equal to 39 GU, greater than or equal to 44 GU, or greater than or equal to 49 GU. In some embodiments, the polyethylene copolymer has a melt index I₂ in the range of 0.40 g/10 min. to 0.60 g/10 min. and a gloss at 450 of greater than or equal to 53 GU, greater than or equal to 58 GU, or greater than or equal to 63 GU.
a haze of less than or equal to (20.47−(10.33×(I₂)))%, less than or equal to (15.47−(10.33×(I₂)))%, or less than or equal to (10.47−(10.33×(I₂))), wherein I₂ is provided in g/10 min.. In some embodiments, the polyethylene copolymer has a melt index I₂ in the range of 0.10 g/10 min. to 0.30 g/10 min. and has a haze of less than or equal to 21%, less than or equal to 16%, or less than or equal to 11%. In some embodiments, the polyethylene copolymer has a melt index I₂ in the range of 0.40 g/10 min. to 0.60 g/10 min. and a haze of less than or equal to 18%, less than or equal to 13%, or less than or equal to 8%.

The polyethylene copolymers provided herein exhibit similar comonomer incorporation along all various chain lengths, with a slightly higher degree of preferential comonomer incorporation on middle- and long-chain branches as compared to short polymer chains. This phenomenon can be characterized using a weight average molecular weight-specific (M_{w}-specific) Chemical Composition Distribution Index (CCDI). The M_{w}-specific CCDI can be considered as:

$$d ( comonomer \% / d ( log {M}_{w} )$$

The M_{w}-specific comonomer slope index (“CSI”) CCDI is calculated by plotting comonomer % against log(MW) (both measured by GPC with IR detector, as described below) in the region between log(M_{w}) values of 4.0 and 5.5, and the M_{w}-specific CSI CCDI is taken as the derivative of that comonomer % plot with respect to log(MW). More particularly, the plot of comonomer wt % against log(MW) is fit to a line and the slope of the line in the region just described is the M_{w}-specific Mₙ-M_{z} CCDI.

The M_{w}-specific Mₙ-M_{z} CCDI can alternatively be normalized to a short-chain branching slope index (M_{w}-specific SCB-SI) CCDI by conversion of the comonomer wt % to short-chain branches per 1000 carbons (SCB/1000C) using the molecular weights of ethylene and the comonomer. The polyethylene copolymers provided herein can have a M_{w}-specific SCB-SI CCDI within the range from a low of any one of 2.0, 2.1, 2.2, 2.3, 2.4, 2.5, 2.6, 2.7, 2.8, 2.9, or 3.0; and less than or equal to any one of 6.0, 5.9, 5.8, 5.7, 5.6, 5.5, 5.4, 5.3, 5.2, 5.1, or 5.0, with ranges from any foregoing low end to any foregoing high end (e.g., 2.0 to 6.0, or 3.0 or 5.0) contemplated herein.

While the foregoing parameter M_{w}-specific CSI CCDI in the region 4.0≤log(M_{w})≤5.5 is of particular interest, it is also useful to define this phenomenon independent of the exact values of log(MW), and instead more generally compare comonomer incorporation is (short-chain branch content) at the high molecular weight chains of the polymer composition vs. the comonomer incorporation (short-chain branch content) at the low molecular weight chains of the polymer composition, irrespective of the length of those chains. For instance, a “5-95 CSI CCDI” may be developed, in which one compares comonomer wt % at two x-values in a GPC plot of dWt %/dlog(MW) vs. log(MW): (1) at the “5% value”, which is the x-value (log(MW) value) at which area under the GPC curve (from x=0 to x=the 5% value) is 5% of the total area under the GPC curve; and (2) at the “95% value”, which is the x-value (log(MW) value) at which area under the GPC curve (from x=0 to x=the “95%” value) is 95% of the total area under the GPC curve. The 5-95 CSI CCDI can be found as the slope of the linear regression of comonomer wt % vs. log(MW) between these two points (essentially, the exercise is the same as described above with respect to 4.0≤log(M_{w})≤5.5, only log(MW)=4.0 is replaced with log(MW)=the 5% value; and log(MW)=5.5 is replaced with log(MW)=the 95% value). In some embodiments, the 5-95 CSI CCDI is normalized to a short-chain branching slope index (5-95 SCB-SI) CCDI by conversion of the comonomer wt % to short-chain branches per 1000 carbons (SCB/1000C) using the molecular weights of ethylene and the comonomer.

Polyethylene compositions according to various embodiments can exhibit a 5-95 SCB-SI CCDI within the range from a low of any one of 2.0, 2.1, 2.2, 2.3, 2.4, 2.5, 2.6, 2.7, 2.8, 2.9, or 3.0; and less than or equal to any one of 6.0, 5.9, 5.8, 5.7, 5.6, 5.5, 5.4, 5.3, 5.2, 5.1, or 5.0, with ranges from any foregoing low end to any foregoing high end (e.g., 2.0 to 6.0, or 3.0 or 5.0) contemplated herein.

The degree of preferential comonomer incorporation along the low, middle, and high molecular-weight chains of the polyethylene copolymer can also be characterized by an “Mₙ-M_{z} Comonomer Slope Index” (Mₙ-M_{z} CSI). This index is determined the same as the 5-95 CSI CCDI, except that instead of using log(MW)=“the 5% value” and log(MW)=“the 95% value” as the low and high points of the slope determination, log(MW)=log(Mₙ) as the low point and log(MW)=log(M_{z}) as the high point for slope determination (again using linear regression in the same manner as described above for M_{w}-specific CCDI and 5-95 CCDI). In some embodiments, the Mₙ-M_{z} CSI CCDI is normalized to a short-chain branching slope index (Mₙ-M_{z} SCB-SI) CCDI by conversion of the comonomer wt % to short-chain branches per 1000 carbons (SCB/1000C) using the molecular weights of ethylene and the comonomer.

The polyethylene copolymers provided herein may exhibit a Mₙ-M_{z} SCB-SI CCDI within the range from a low of any one of 2.0, 2.1, 2.2, 2.3, 2.4, 2.5, 2.6, 2.7, 2.8, 2.9, or 3.0; and is less than or equal to any one of 8.0, 7.9, 7.8, 7.7, 7.6, 7.5, 7.4, 7.3, 7.2, 7.1, or 7.0, with ranges from any foregoing low end to any foregoing high end (e.g., 2.0 to 8.0, or 3.0 or 7.0) contemplated herein.

Linear regression of the comonomer wt % vs. log(MW) plot, whether for M_{W}-specific CCDI, 5-95 CCDI, Mₙ-M_{z} CSI or otherwise, may be carried out by any suitable method, such as linear regression fit of comonomer wt % vs. log(M_{w}) by using suitable software, such as EXCEL™ from Microsoft. Linear regression should be carried out with a minimum of 30 data points for comonomer wt % vs. log(M_{w}), preferably greater than or equal to 100 data points.

Another parameter useful for demonstrating the similar degree of comonomer incorporation along low, middle, and high molecular-weight chains of the polyethylene copolymer is the Composition Distribution Breadth Index (CDBI). As noted, the polyethylene copolymers can have a CDBI of 85% or more, such as 90% or more. CDBI is defined as the weight percent of the copolymer molecules having a comonomer content within 50% of the median total molar comonomer content (i.e., within a range from 0.5× median to 1.5× median), and it is described in U.S. Pat. No. 5,382,630, which is hereby incorporated by reference. The CDBI of a copolymer is readily determined utilizing well known techniques for isolating individual fractions of a sample of the copolymer. One such technique is Temperature Rising Elution Fraction (TREF), as described in Wild, et al., L Poly. Sci., Poly. Phys. Ed., vol. 20, p. 441 (1982) and U.S. Pat. No. 5,008,204, which are incorporated herein by reference. In some embodiments, the polyethylene copolymer has a CDBI greater than or equal to 70%, 75%, 80%, 85%, or 90%.

Any two or more of the foregoing attributes of I₂, I₂₁, MIR, density, g′, comonomer percentage, M_{w}, M_{z}, Mₙ, M_{w}/Mₙ, M_{z}/M_{w}, M_{z}/Mₙ, gloss (45°), haze, CCDI, and CDBI can be combined (with each property within the respective ranges as described above) for different embodiments of the invention.

### Polymerization Processes

The polyethylene copolymers can be made in gas phase polymerization systems. One or more reactors in series or in parallel can be used. In some embodiments, a catalyst component and activator can be delivered as a solution or slurry, either separately to the reactor, activated in-line just prior to the reactor or in the reactor, or preactivated and pumped as an activated solution or slurry to the reactor.

Polymerizations can be carried out in either (a) single reactor operation, wherein ethylene, olefin comonomer(s), catalyst/activator, scavenger, and optional modifiers are added is continuously to a single reactor or (b) series reactor operation, wherein the components are added to each of two or more reactors connected in series. In various embodiments employing series reactors, the catalyst components may be added to the first reactor in the series. Going further, however, the catalyst component may be added to multiple reactors, with one component being added to first reactor and another component added to other reactors.

In some embodiments, the polymerization process includes a gas phase polymerization reaction, and in particular a fluidized bed gas phase polymerization reaction. The gas-phase polymerization may be carried out in any suitable reactor system, e.g., a stirred- or paddle-type reactor system. See U.S. Pat. Nos. 7,915,357; 8,129,484; 7,202,313; 6,833,417; 6,841,630; 6,989,344; 7,504,463; 7,563,851; and 8,101,691 for discussion of suitable gas phase fluidized bed polymerization systems, which are well known in the art.

In such polymerization processes, a gas-phase, fluidized-bed process is conducted by passing a stream containing ethylene and an olefin comonomer continuously through a fluidized-bed reactor under reaction conditions and in the presence of a catalyst composition at a velocity sufficient to maintain a bed of solid particles in a suspended state. A stream (which may be called a “cycle gas” stream) containing unreacted ethylene and olefin comonomer is continuously withdrawn from the reactor, compressed, cooled, optionally partially or fully condensed, and recycled back to the reactor. Prepared polyethylene copolymer is withdrawn from the reactor and replacement ethylene and olefin comonomer are added to the recycle stream. In some embodiments, gas inert to the catalyst composition and reactants is present in the gas stream.

The cycle gas can include induced condensing agents (“ICA”). An ICA is one or more non-reactive alkanes that are condensable in the polymerization process for removing the heat of reaction. In some embodiments, the non-reactive alkanes are selected from C₁-C-5 alkanes, e.g., one or more of propane, butane, isobutane, pentane, isopentane, hexane, as well as isomers thereof and derivatives thereof. In some instances, mixtures of two or more such ICAs may be particularly desirable (e.g., propane and pentane, propane and butane, butane and pentane, etc.).

In some embodiments, operation of gas phase fluidized bed reactors employing ICA can take place in “dry mode” (typically less than 5 mol % total ICA concentration with respect to total cycle gas), in contrast to “condensing” or “condensed” mode, with higher ICA concentrations. In some embodiments, the gas phase process is substantially free of ICA. As noted, it may be desired to maximize ICA concentration for faster commercial runtimes; however, as discussed in connection with the Examples below, reducing ICA may have beneficial effects on comonomer distribution. In particular, according to various embodiments, polymerization processes may employ less than 5 mol % ICA (concentration based on total cycle gas), such as 4 mol % or less, 3 mol % or less, 2 mol % or less, 1 mol % or less, or no ICA.

PCT pub. no. WO2021/221904A1 discloses improved resistance to stress cracking in polyethylene copolymers having a density of 0.931 to 0.936 g/cm³. IP.com pub. no. IPCOM000268060D discloses the use of ICA content in the range of 10 mol % to 18 mol % during gas phase polymerization of ethylene-butene mLLDPEs having a density of 0.910 to 0.960 g/cm³ to control rheology and melt strength. In contrast, examples herein show an unexpected reduction in melt viscosity during extrusion for the low density, low melt index I₂ polyethylene copolymers disclosed herein, in particular ethylene-hexene copolymers, by further limiting the gas phase process to the dry mode, as defined above. Examples herein further show a reduction in melt viscosity during extrusion as compared to similar polyethylene copolymers disclosed in IP.com pub. no. IPCOM000266833D.

Producing the polyethylene copolymers disclosed herein in a gas phase polymerization process in the dry mode, as defined herein, is suitable for producing polyethylene compositions with the desired 5-95 CCDI. That is, according to certain embodiments in which the polyethylene composition is made using a gas phase polymerization process, chemical composition distribution (i.e., comonomer distribution along polymer chains) may be effectively controlled at least in part using induced condensing agent (ICA) concentration, while also controlling for particular melt index and density. Typically, higher ICA concentration is preferred, which enables faster production rates (which are of course typically desired); however, this can negatively impact the 5-95 CCDI, which directly affects melt viscosity. It was surprisingly and unexpectedly discovered that minor adjustments in the ICA concentration (e.g., targeting a slightly lower ICA concentration) reduces melt viscosity while maintaining melt strength. In particular, operating at mol % ICA or less may result in polyethylene copolymers having the desired 0.3 or greater 5-95 CCDI in addition to a reduced melt viscosity.

The polymerization process can be conducted substantially in the absence of catalyst poisons such as moisture, oxygen, carbon monoxide and acetylene. However, it is noted that oxygen may be added back to the reactor to alter the polymer structure and the polymer's performance characteristics.

Further, organometallic compounds can be employed as scavenging agents to remove catalyst poisons, thereby increasing the catalyst activity, or for other purposes. Adjuvants may also or instead be used in the process. Similarly, hydrogen gas may be added, thereby affecting the polymer molecular weight and distribution.

The amount of hydrogen used in the polymerization process can be an amount necessary to achieve the desired melt index I₂ of the final polyolefin polymer. For example, the mole ratio of hydrogen to total monomer (H₂/monomer) can be 0.0001 or greater, 0.0005 or greater, or 0.001 or greater. Further, the mole ratio of hydrogen to total monomer (H₂/monomer) can be 10 or less, 5 or less, 3 or less, or 0.10 or less. A range for the mole ratio of hydrogen to monomer can include any combination of any upper mole ratio limit with any lower mole ratio limit described herein. The amount of hydrogen in the reactor at any time can range to up to 5,000 ppm, up to 4,000 ppm in another embodiment, up to 3,000 ppm, or from 50 ppm to 5,000 ppm, or from 50 ppm to 2,000 ppm in another embodiment. The amount of hydrogen in the reactor can range from 1 ppm, 50 ppm, or 100 ppm to 400 ppm, 800 ppm, 1,000 ppm, 1,500 ppm, or 2,000 ppm, based on weight. Further, the ratio of hydrogen to total monomer (H₂/monomer) can be 0.00001:1 to 2:1, 0.005:1 to 1.5:1, or 0.0001:1 to 1:1. The one or more reactor pressures in a gas phase process (either single stage or two or more stages) can vary from 690 kPa (100 psig) to 3,448 kPa (500 psig), in the range from 1,379 kPa (200 psig) to 2,759 kPa (400 psig), or in the range from 1,724 kPa (250 psig) to 2,414 kPa (350 psig).

Often, a continuous cycle is employed wherein a first part of the cycle of a reactor, a cycling gas stream, otherwise known as a recycle stream or fluidizing medium, is heated in the reactor by the heat of polymerization. This heat is removed in a second part of the cycle by a cooling system external to the reactor.

The reactor pressure may vary from 100 psig (680 kPag)-500 psig (3448 kPag), from 200 psig (1379 kPag)-400 psig (2759 kPag), or from 250 psig (1724 kPag)-350 psig (2414 kPag). In some embodiments, the reactor is operated at a temperature in the range of 60° C. to 120° C., 60° C. to 115° C., 70° C. to 110° C., 70° C. to 95° C., or 85° C. to 95° C.

The mole percent of ethylene may be from 25.0-90.0 mole percent, or 50.0-90.0 mole percent, or 70.0-85.0 mole percent, and the ethylene partial pressure is in the range of 30 from 75 psia (517 kPa)-300 psia (2069 kPa), or 100-275 psia (689-1894 kPa), or 150-265 psia (1034-1826 kPa), or 200-250 psia (1378-1722 kPa). Ethylene concentration in the reactor can also range from 35-95 mol %, such as within the range from a low of 35, 40, 45, 50, or 55 mol % to a high of 70, 75, 80, 85, 90, or 95 mol % and further where ethylene mol % is measured on the basis of total moles of gas in the reactor (including, if present, ethylene and/or comonomer gases as well as inert gases such as one or more of nitrogen, isopentane or other ICA(s), etc.); as with vol-ppm hydrogen, this measurement may for convenience be taken in the cycle gas outlet rather than in the reactor itself. Comonomer concentration can range from 2.0-6.0 mol %, 2.2-5.6 mol %, 2.4-5.2 mol %, 2.6-4.8 mol %, 2.8-4.4 mol %, 3.0-4.0 mol %.

Overall continuous gas phase process for the polymerization of a polyethylene may thus comprise: continuously circulating a feed gas stream containing monomer and inerts to thereby fluidize and agitate a bed of polymer particles, adding metallocene catalyst to the bed and removing polymer particles in which:
a) the catalyst comprises at least one bridged bis cyclopentadienyl transition metal and an alumoxane activator on a common or separate porous support;
b) the feed gas is substantially devoid of a Lewis acidic scavenger and wherein any Lewis acidic scavenger is preferably present in an amount less than 100 wt. ppm of the feed gas;
c) the temperature in the bed is no more than 20° C. less than the polymer melting temperature as determined by DSC, at a ethylene partial pressure in excess of 60 pounds per square inch absolute (414 kPaa), and
d) the removed polymer particles have an ash content of transition metal of less than 500 wt. ppm, the MI is less than 10, the MIR is at least 35 with the polymer having substantially no detectable chain end unsaturation as determined by HNMR.

By the statement that the polymer has substantially no detectable end chain unsaturation, it is meant that the polymer has vinyl unsaturation of less than 0.1 vinyl groups per 1000 carbon atoms in the polymer, e.g., less than 0.05 vinyl groups per 1000 carbon atoms, e.g., 0.01 vinyl groups per 1000 carbon atoms or less.

The process aims to provide the polyethylene of the invention through the use of a single catalyst and the process does not depend on the interaction of bridged and unbridged species. Preferably the catalyst is substantially devoid of a metallocene having a pair of pi bonded ligands (e.g., cyclopentadienyl compounds) which are not connected through a covalent bridge, in other words, no such metallocene is intentionally added to the catalyst, or preferably, no such metallocene can be identified in such catalyst, and the process uses substantially a single metallocene species comprising a pair of pi bonded ligands at least one of which has a structure is with at least two cyclic fused rings (e.g., indenyl rings). Best results may be obtained by using a substantially single metallocene species comprising a mono-atom silicon bridge connecting two polynuclear ligands pi bonded to the transition metal atom.

### Catalyst System

In particular, it is thought desirable to use a catalyst system in which the metallocene has a pair of bridged cyclopentadienyl groups, preferably with the bridge consisting of a single carbon, germanium or silicon atom so as to provide an open site on the catalytically active cation. In some embodiments, the metallocene catalyst component is represented by the formula:

$$( {C}_{5} {R}_{m}^{′} ) {pR}_{s}^{″} ( {C}_{5} {R}_{m}^{′} ) {Q}_{2}$$

wherein:
M is a Group 4, 5, 6 transition metal;
at least one C₅R′ₘ is a substituted cyclopentadienyl;
each R′, which can be the same or different is hydrogen, alkyl, alkenyl, aryl, alkylaryl, or arylalkyl radical having from 1 to 20 carbon atoms or two carbon atoms joined together to form a part of a substituted or unsubstituted ring or rings having 4 to 20 carbon atoms;
R″ is one or more of or a combination of a carbon, a germanium, a silicon, a phosphorous or a nitrogen atom containing radical bridging two (C₅ R′ₘ) rings; and
each Q which can be the same or different is an aryl, alkyl, alkenyl, alkylaryl, or arylalkyl radical having from 1 to 20 carbon atoms, halogen, or alkoxides.

In some embodiments, the catalyst is dimethylsilyl-bis-(tetrahydroindenyl) zirconium dichloride (Me₂Si(H₄Ind)₂ZrCl₂).

The activator may be methyl alumoxane as described in U.S. Pat. Nos. 5,324,800; 5,580,939; and 5,633,394, incorporated by reference herein, (EP-129368) or a noncoordinated anion as described in U.S. patent application Ser. No. 08/133,480, incorporated by reference herein, (EP-277004). It also thought desirable that there should be substantially no scavengers which may interfere with the reaction between the vinyl end unsaturation of polymers formed and the open active site on the cation. By the statement “substantially no scavengers” and “substantial devoid or free of Lewis acid scavengers”, it is meant that there should be less than 100 ppm by weight of such scavengers present in the feed gas, or preferably, no intentionally added scavenger, e.g., an aluminum alkyl scavenger, other than that which may be present on the support.

The conditions optimal for the production of the polyethylene of the invention also is require steady state polymerization conditions which are not likely to be provided by batch reactions in which the amounts of catalyst poisons can vary and where the concentration of the comonomer may vary in the production of the batch.

The catalyst is preferably supported on silica with the catalyst homogeneously distributed in the silica pores. Preferably, fairly small amounts of methyl alumoxane should be used, such as amounts giving an Al to transition metal ratio of from 400 to 30, and especially of from 200 to 50.

In order to obtain a desired melt index ratio, the molar ratio of ethylene and comonomer can be varied, as can concentration of the comonomer. Control of the temperature can help control the MI. Overall monomer partial pressures may be used which correspond to conventional practice for gas phase polymerization of LLDPE.

### Articles of Manufacture

The polyethylene copolymers described herein can be particularly suitable for making end-use articles of manufacture such as films (e.g., as may be formed by lamination, extrusion, coextrusion, casting, and/or blowing); as well as other articles of manufacture as may be formed, e.g., by blow molding. Film formation processes are well known in the art, and the skilled artisan will readily recognize applications of LLDPE for film making. However, we note that uses of the polyethylene copolymer provided herein can be applications, including but not limited to, stretch hood greenhouse films, construction liners, blown geomembrane, shrink film, food packaging, and liquid packaging. In some embodiments, the polyethylene copolymer can be used in a formulated composition.

In some embodiments, the article of manufacture is a film. The film can be formed by lamination, extrusion, or coextrusion. In some embodiments, the film can be embossed. Particularly useful films include those where high melt strength and low melt viscosity are advantageous such as those produced in large diameter blown film operations.

### Certain Embodiments

In some embodiments, a polyethylene copolymer, as described herein, comprises ethylene-derived units and units derived from at least one or only one olefin comonomer having 4 to 8 carbon atoms, and has:
a) a density in the range of from 0.908 g/cm³ to 0.916 g/cm³;
b) a melt index h in the range of from 0.10 g/l 0 min. to 060 g/10 min.;
c) a melt index ratio I₂₁/I₂ of greater than or equal to 46.9−(33.3×(I₂)) a melt index ratio I₂₁/I₂ of greater than or equal to 51.8−(33.3×(I₂)), 52.8−(33.3×(I₂)), or greater than or equal to 55.1−(33.3×(I₂)), wherein I₂ is provided in g/10 min., wherein I₂ is provided in g/10 min.; and
d) optionally, a branching index g′ᵥᵢₛ in the range of from 0.940 to 0.960.

In further embodiments, in addition to the foregoing attributes, the polyethylene copolymer has one or more of the following attributes:
a) a comonomer content in the range of from 9.0 wt. % to 11.0 wt. %;
b) the at least one olefin comonomer is butene, hexene, or a combination thereof, 1-butene, 1-hexene, or a combination thereof, 1-butene; or 1-hexene;
c) a density in the range of ((0.0025×W)+(0.0056×*I₂)+0.9353) g/cm³±0.001 g/cm³, wherein W is the weight percent comonomer incorporated into the polyethylene copolymer and I₂ is provided in g/10 min.; in the range of from 0.908 g/cm³ to 0.915 g/cm³. 0.909 g/cm³ to 0.914 g/cm³. or 0.910 g/cm³ to 0.913 g/cm³, when the polyethylene copolymer has a melt index I₂ in the range of from 0.10 g/10 min. to 0.30 g/10 min.; or in the range of from 0.910 g/cm³, to 0.916 g/cm³, 0.911 g/cm³ to 0.915 g/cm³, or 0.912 g/cm³ to 0.914 g/cm³, when the polyethylene copolymer is in the range of from 0.40 g/10 min. to 0.60 g/10 min.;
d) a weight average molecular weight M_{w} in the range of ((2,900×W)−(63,500×I₂)+110,300) g/mol±1,000 g/mol, ±2,000 g/mol, or ±5,000 g/mol, wherein W is the weight percent comonomer incorporated into the polyethylene copolymer and I₂ is provided in g/10 min.; in the range of 117,400 g/mol to 135,900 g/mol, 120,300 g/mol to 133,000 g/mol, 120,600 g/mol to 132,700 g/mol, or 123,200 g/mol to 130,100 g/mol, when the polyethylene copolymer has a melt index I₂ in the range of 0.10 g/10 min. to 0.30 g/10 min.; or in the range of 98,300 g/mol to 116,800 g/mol, 101,200 g/mol to 133,900 g/mol, 101,500 g/mol to 113,700 g/mol, or 104,100 g/mol to 111,000 g/mol, when the polyethylene copolymer has a melt index I₂ in the range of 0.40 g/10 min. to 0.60;
e) a Z-average molecular weight M_{z} in the range of ((2,360×W)−(125,900×I₂)+252,000) g/mol±500 g/mol, ±1000 g/mol, or ±2,500 g/mol, wherein W is the weight percent comonomer incorporated into the polyethylene copolymer and I₂ is provided in g/10 min.; in the range of 235,000 g/mol to 265,000 g/mol, 238,000 g/mol to 263,000 g/mol, 240,000 g/mol to 261,000 g/mol, or 242,000 g/mol to 259,000 g/mol, when the polyethylene copolymer has a melt index I₂ in the range of 0.10 g/10 min. to 0.30 g/10 min.; or in the range of 197,500 g/mol to 227,000 g/mol, 200,000 g/mol to 225,000 g/mol, 202,000 g/mol to 223,000 g/mol, or 204,000 g/mol to 221,100 g/mol, when the polyethylene copolymer has melt index 12 in the range of 0.40 g/10 min. to 0.60 g/10 min.;
f) a number average molecular weight Mₙ in the range of ((1,027×W)−(18,620×I₂)+31,500) g/mol±250 g/mol, ±500 g/mol, or ±1,250 g/mol, wherein W is the weight percent comonomer incorporated into the polyethylene copolymer and I₂ is provided in g/10 min.; in the range of 35,200 g/mol to 41,000 g/mol, 36,100 g/mol to 40,000 g/mol, 36,200 g/mol to 39,900 g/mol, or 37,000 g/mol to 39,100 g/mol, when the polyethylene copolymer has a melt index I₂ in the range of 0.10 g/10 min. to 0.30 g/10 min.; or in the range of 29,600 g/mol to 35,400 g/mol, 30,500 g/mol to 34,400 g/mol, 30,600 g/mol to 34,300 g/mol, or 31,500 g/mol to 33,500 g/mol, when the polyethylene copolymer has a melt index I₂ in the range of 0.40 g/10 min. to 0.60 g/10 min.;
g) a molecular weight distribution M_{w}/Mₙ in the range of from 3.27 to 3.46;
h) a molecular weight distribution M_{z}/M_{w} less than or equal to 2.0;
i) a molecular weight distribution M_{z}/Mₙ in the range of from 6.42 to 6.95;
j) a gloss at 450 of greater than or equal to (33.67+(46.67×(I₂))) GU, greater than or equal to (38.67+(46.67×(I₂))) GU, or greater than or equal to (43.67+(46.67×(I₂))) GU; greater than or equal to 39 GU, greater than or equal to 44 GU, or greater than or equal to 49 GU, when the polyethylene copolymer has a melt index I₂ in the range of 0.10 g/10 min. to 0.30 g/10 min.; or greater than or equal to 53 GU, greater than or equal to 58 GU, or greater than or equal to 63 GU, when the polyethylene copolymer has a melt index I₂ in the range of 0.40 g/10 min. to 0.60 g/10 min.;
k) a haze of less than or equal to (20.47−(10.33×(I₂)))%, less than or equal to (15.47−(10.33×(I₂)))%, or less than or equal to (10.47−(10.33×(I₂)))%; less than or equal to 21%, less than or equal to 16%, or less than or equal to 11%, when the polyethylene copolymer has a melt index I₂ in the range of 0.10 g/10 min. to 0.30 g/10 min.; or less than or equal to 18%, less than or equal to 13%, or less than or equal to 8%, when the polyethylene copolymer has a melt index I₂ in the range of 0.40 g/10 min. to 0.60 g/10 min.;
l) a composition distribution breadth index (“CDBI”) greater than or equal to 70%, 75%, 80% or 85%; and
m) a SCB-SI CCDI of greater than or equal to 3.0, which can further be specified as one of the following:
   i) a M_{w}-specific SCB-SI CCDI within the range from a low of any one of 2.0, 2.1, 2.2, 2.3, 2.4, 2.5, 2.6, 2.7, 2.8, 2.9, or 3.0; and less than or equal to any one of 6.0, 5.9, 5.8, 5.7, 5.6, 5.5, 5.4, 5.3, 5.2, 5.1, or 5.0, with ranges from any foregoing low end to any foregoing high end (e.g., 2.0 to 6.0, or 3.0 or 5.0) contemplated herein;
   ii) a 5-95 SCB-SI CCDI within the range from a low of any one of 2.0, 2.1, 2.2, 2.3, 2.4, 2.5, 2.6, 2.7, 2.8, 2.9, or 3.0; and less than or equal to any one of 6.0, 5.9, 5.8, 5.7, 5.6, 5.5, 5.4, 5.3, 5.2, 5.1, or 5.0, with ranges from any foregoing low end to any foregoing high end (e.g., 2.0 to 6.0, or 3.0 or 5.0) contemplated herein; and
   iii) a Mₙ-M_{z} SCB-SI CCDI within the range from a low of any one of 2.0, 2.1, 2.2, 2.3, 2.4, 2.5, 2.6, 2.7, 2.8, 2.9, or 3.0; and less than or equal to any one of 8.0, 7.9, 7.8, 7.7, 7.6, 7.5, 7.4, 7.3, 7.2, 7.1, or 7.0, with ranges from any foregoing low end to any foregoing high end (e.g., 2.0 to 8.0, or 3.0 or 7.0) contemplated herein.

In further embodiments of the polyethylene copolymer, the comonomer is hexene and the polyethylene copolymer is an ethylene-hexene copolymer having:
a) a melt index I₂ in the range of 0.10 g/10 min. to 0.30 g/10 min. and a melt index ratio I₂₁/I₂ of greater than or equal to 45.1, 48.5, or 51.8; or
b) a melt index I₂ in the range of 0.40 g/10 min. to 0.60 g/10 min. and a melt index ratio I₂₁/I₂ of greater than or equal to 35.1, 38.5, or 41.8.

In some aspects, a continuous gas phase process for the production of a polyetheylene copolymer is provided. The process comprises:
a) continuously passing a gaseous stream, comprising ethylene and at least one olefin comonomer having from 4 to 8 carbon atoms, through a fluidized bed reactor in the presence of a metallocene catalyst under polymerization conditions, is wherein polymerization conditions comprise an ethylene partial pressure greater than or equal to 1300 kPaa and a reactor pressure of less than or equal to 10,000 kPag;
b) withdrawing the polyethylene copolymer and a stream comprising unreacted ethylene, unreacted comonomer, and induced condensing agent, wherein the induced condensing agent comprises less than 5 mol % of the stream;
c) cooling the stream, comprising unreacted ethylene, unreacted comonomer, and optionally an induced condensing agent, to form a cooled stream, wherein the cooled stream is substantially free of a liquid phase; and
d) feeding the cooled stream to the fluidized bed reactor with sufficient additional ethylene and at least one comonomer to replace the ethylene and at least one comonomer polymerized and withdrawn as the polyethylene copolymer.

In some embodiments, in addition to the foregoing attributes of the process, the metallocene catalyst composition on is represented by the formula, (C₅R′ₘ)ₚR″ₛ(C₅R′ₘ)Q₂, wherein:
M is a Group 4, 5, 6 transition metal;
at least one C₅R′ₘ is a substituted cyclopentadienyl;
each R′, which can be the same or different is hydrogen, alkyl, alkenyl, aryl, alkylaryl, or arylalkyl radical having from 1 to 20 carbon atoms or two carbon atoms joined together to form a part of a substituted or unsubstituted ring or rings having 4 to carbon atoms;
R″ is one or more of or a combination of a carbon, a germanium, a silicon, a phosphorous or a nitrogen atom containing radical bridging two (C₅R′ₘ) rings; and
each Q which can be the same or different is an aryl, alkyl, alkenyl, alkylaryl, or arylalkyl radical having from 1 to 20 carbon atoms, halogen, or alkoxides.

In further embodiments of the process, the metallocene catalyst is dimethylsilyl-bis-(tetrahydroindenyl) zirconium dichloride (Me₂Si(H₄Ind)₂ZrCl₂).

In further embodiments, in addition to one or more of the foregoing attributes of the process, the at least one olefin comonomer is butene, hexene, or a combination thereof.

In further embodiments, in addition to one or more of the foregoing attributes of the process, the process is further characterized by one or more of:
a) a reactor bed temperature in the range of from 60° C. to 120° C., 60° C. to 115° C., 70° C. to 110° C., 70° C. to 95° C., or 85° C. to 95° C.;
b) a reactor pressure in the range of from 100 psig (680 kPag) to 500 psig (3448 kPag), from 200 psig (1379 kPag) to 400 psig (2759 kPag), or from 250 psig (1724 kPag) to 350 psig (2414 kPag);
c) a molar ratio of comonomer to ethylene in the range of from 2% to 6%; from 4% to 6% when the comonomer is butene or 1-butene; from 3% to 4% when the comonomer is hexene or 1-hexene; or from 2% to 3% when the comonomer is octene or 1-octene;
d) a mass flow ratio of comonomer to ethylene in range of from 9.5 kg comonomer/kg ethylene to 12.5 kg comonomer/kg ethylene;
e) an ethylene partial pressure greater than or equal to 600 kPaa, greater than or equal to 600 kPaa; greater than or equal to 800 kPaa; greater than or equal to 1000 kPaa; or greater than or equal to 1,200 kPaa;
f) an ethylene concentration in the range of from 94.5 mol % to 98.0 mol %; from 94.5% to 96.0% when the comonomer is butene or 1-butene; from 96.0% to 97.5% when the comonomer is hexene or 1-hexene; or from 97.0% to 98.0% when the comonomer is octene or 1-octene;
g) a hydrogen to total monomer ratio of from 5 ppm/mol to 15 ppm/mol; and
h) a hydrogen concentration in the range of from 1 ppm, 50 ppm, or 100 ppm to 400 ppm, 800 ppm, 1,000 ppm, 1,500 ppm, or 2,000 ppm, based on weight.

In another aspect, a polyethylene copolymer is produced as the product of any one of the above embodiments of the process.

### Examples

The following examples are included to demonstrate some embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

The foregoing discussion can be further described with reference to the following non-limiting examples. Polyethylene copolymers, according to one or more embodiments provided herein, were produced in six gas phase polymerization systems (Examples I-6). Each copolymer specimen was characterized for its I₂, I₂₁, MIR, density, g′, comonomer percentage, M_{w}, M_{z}, Mₙ, M_{w}/Mₙ, M_{z}/M_{w}, and M_{z}/Mₙ.

### Test Methods/Polymer Characterization

Density (g/cm³): Density measurements were made following ASTM D-1505.

Dynamic Mechanical Analysis (DMA) rheological measurements (e.g. small-strain (10%) oscillatory shear measurements) were carried out on a dynamic Rheometrics SR5 Stress rotational rheometer with 25 mm diameter parallel plates in a frequency sweep mode under full nitrogen blanketing. The polymer samples are appropriately stabilized with the anti-oxidant additives and then inserted into the test fixture for at least one minute preheating to ensure the normal force decreasing back to zero. All DMA experiments are conducted at 10% strain, 0.05 to 100 rad/s and 190° C. Orchestrator Software is used to determine the viscoelastic parameters including the storage modulus (G′), loss modulus (G″), phase angle (δ), complex modulus (G″) and complex viscosity (η*). The values of storage modulus G′ were estimated at a constant value of loss modulus G″ at 500 Pa at 190° C. (G′ at G″ (500 Pa). This is to characterize and discriminate the viscoelastic properties of the comparative and inventive copolymers. This test technique provides an opportunity to study the various characteristics of a polymer melt where the elastic and viscous modulus (G′ and G″), viscosity (η*), and tan δ as a function of dynamic oscillation (frequency) are generated to provide information on the rheological behavior in correlation with the molecular architecture.

Gel permeation chromatography (“GPC”) 4D Methodology:
a) Unless otherwise indicated, the distribution and the moments of molecular weight (M_{w}, Mₙ, M_{z}, M_{w}/Mₙ, etc.), the comonomer content (C₂, C₃, C₆, etc.), the branching index (g′), and CCDI (M_{w}-specific, 5-95, and Mₙ-M_{z}) are determined by using a high temperature Gel Permeation Chromatography (Polymer Char GPC-R) equipped with a multiple-channel band-filter based Infrared detector IR5, an 18-angle light scattering detector and a viscometer. Three Agilent PLgel 10-μm Mixed-B LS columns are used to provide polymer separation. Aldrich reagent grade 1,2,4-trichlorobenzene (“TCB”) with 300 ppm antioxidant butylated hydroxytoluene (“BHT”) is used as the mobile phase. The TCB mixture is filtered through a 0.1-μm Teflon filter and degassed with an online degasser before entering the GPC instrument. The nominal flow rate is 1.0 ml/min. and the nominal injection volume is 200 μl. The whole system including transfer lines, columns, and detectors are contained in an oven maintained at 145° C. Given amount of polymer sample is weighed and sealed in a standard vial with 80-μl flow marker (heptane) added to it. After loading the vial in the autosampler, polymer is automatically dissolved in the instrument with 8 ml added TCB solvent. The polymer is dissolved at 160° C. with continuous shaking for about 1 hour for most polyethylene samples or 2 hours for polypropylene samples. The TCB densities used in concentration calculation are 1.463 g/ml at room temperature and 1.284 g/ml at 145° C. The sample solution concentration is from 0.2 to 2.0 mg/ml, with lower concentrations being used for higher molecular weight samples. The concentration (c), at each point in the chromatogram is calculated from the baseline-subtracted IR5 broadband signal intensity (I), using the following equation: c=βI, where β is the mass constant. The mass recovery is calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M g/mole. The MW at each elution volume is calculated with following equation:

$$log M = \frac{log ( {K}_{PS} / K )}{α + 1} + \frac{{α}_{PS} + 1}{α + 1} log {M}_{PS} ,$$

where the variables with subscript “PS” stand for polystyrene while those without a subscript are for the test samples. In this method, β_{PS}=0.67 and K_{PS}=0.000175, while α and K for other materials are as calculated and published in literature (Sun, T. et al. Macromolecules 2001, 34, 6812), except that for purposes of this invention and claims thereto, α=0.695 and K=0.000579 for linear ethylene polymers, α=0.705 and K=0.0002288 for linear propylene polymers, α=0.695 and K=0.000181 for linear butene polymers, α is 0.695 and K is 0.000579×(1−0.0087×w2b+0.000018×(w2b)²) for ethylene-butene copolymer where w2b is a bulk weight percent of butene comonomer, α is 0.695 and K is 0.000579×(1−0.0075× w2b) for ethylene-hexene copolymer where w2b is a bulk weight percent of hexene comonomer, and a is 0.695 and K is 0.000579×(1−0.0077×w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dl/g unless otherwise noted.
a) The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1000 total carbons (“CH₃/1000TC”) as a function of molecular weight. The short-chain branch (“SCB”) content per 1000TC (“SCB/1000TC”) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

$$w 2 = f * SCB / 1000 TC .$$

b) The bulk composition of the polymer from the GPC-IR and GPC-4D analyses is obtained by considering the entire signals of the CH₃ and CH₂ channels between the integration limits of the concentration chromatogram. First, the following ratio is obtained

$$Bulk IR ratio = \frac{Area of {CH}_{3} signal within integration limits}{Area of {CH}_{2} signal within integration limits} .$$

c) Then the same calibration of the CH₂ and CH₃ signal ratio, as mentioned previously in obtaining the CH₃/1000TC as a function of molecular weight, is applied to obtain the bulk CH₃/1000TC. A bulk methyl chain ends per 1000TC (“bulk CH₃end/1000TC”) is obtained by weight-averaging the chain-end correction over the molecular-weight range. Then

$$w 2 b = f * bulk CH 3 / 1000 TC ,$$

$$bulk SCB / 1000 TC = bulk CH 3 / 1000 TC - bulk CH 3 end / 1000 TC ,$$

and bulk SCB/1000TC is converted to bulk w2 in the same manner as described above.
d) The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions, Huglin, M. B., Ed.; Academic Press, 1972.):

$$\frac{{K}_{0} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K₀ is the optical constant for the system:

$${K}_{0} = \frac{4 {π}^{2} {{n}^{2} ( dn / dc )}^{2}}{{λ}^{4} {N}_{A}} ,$$

where N_{A} is Avogadro's number, and (dn/dc) is the refractive index increment for the system. The refractive index, n=1.500 for TCB at 145° C. and λ=665 nm. For analyzing polyethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1−0.00126*w2) ml/mg and A₂=0.0015 where w2 is weight percent butene comonomer.
e) A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, is, for the solution flowing through the viscometer is calculated from their outputs. The intrinsic viscosity, ηₛ, at each point in the chromatogram is calculated from the equation [η]=ηₛ/c, where ηₛ is concentration and is determined from the IR5 broadband channel output. The viscosity MW at each point is calculated as M=K_{PS}M^{aps+1}[η], where αₚₛ is 0.67 and Kₚₛ is 0.000175.
f) The branching index (g′ᵥᵢₛ) calculated using the output of the GPC-IR5-LS-VIS method as follows. The average intrinsic viscosity, [η]_{avg}, of the sample is calculated by:

$${⌊ η ⌋}_{avg} = \frac{\sum {{c}_{i} [ η ]}_{i}}{\sum {c}_{i}} ,$$

where the summations are over the chromatographic slices, i, between the integration limits.
g) The branching index g′ᵥⱼₛ is defined as g′ᵥⱼₛ=([η]_{avg})/(KMᵥ^{α}), where Mᵥ is the viscosity-average molecular weight based on molecular weights determined by LS analysis and the K and a are for the reference linear polymer, which are, for purposes of this invention and claims thereto, α=0.695 and K=0.000579 for linear ethylene polymers, α=0.705 and K=0.0002288 for linear propylene polymers, α=0.695 and K=0.000181 for linear butene polymers, α=0.695 and K is 0.000579×(1−0.0087 w2b+0.000018×(w2b)²) for ethylene-butene copolymer where w2b is a bulk weight percent of butene comonomer, α is 0.695 and K is 0.000579*(1−0.0075× w2b) for ethylene-hexene copolymer where w2b is a bulk weight percent of hexene comonomer, and α is 0.695 and K is 0.000579*(1−0.0077×w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dl/g unless otherwise noted. Calculation of the w2b values is as discussed above.

Gloss (gloss units (“GU”)): Gloss measurements were made following ASTM D-2457 at a 45° angle.

High load melt index (g/10 min. or dg/min.): HLMI, also referred to as 121 or 121.6 in recognition of the 21.6 kg loading used in the test, was measured according to ASTM D-1238, 190° C., 21.6 kg.

Melt index (g/10 min. or dg/min.): MI, also referred to as I₂ or I_{2.16} in recognition of the 2.16 kg loading used in the test, was measured according to ASTM D-1238, 190° C., 2.16 kg.

Small angle oscillatory shear (“SAOS”) frequency sweep melt rheology experiments were performed at 190° C. using a 25 mm cone)(1° and plate configuration on a MCR301 controlled strain/stress rheometer (Anton Paar GmbH). Sample test disks (25 mm diameter, 1 mm thickness) were prepared via compression molding of pellets (which where necessary can be made from fiber samples) at 190° C. using a Schwaben Than laboratory press (200T). Typical cycle for sample preparation is 1 minute without pressure followed by 1.5 minute under pressure (50 bars) and then cooling during 5 minutes between water cooled plates. The sample was first equilibrated at 190° C. for 13 min to erase any prior thermal and crystallization history. An angular frequency sweep was next performed from 500 rad/s to 0.0232 rad/s using 6 points/decade and a strain value of 10% lying in the linear viscoelastic region determined from strain sweep experiments. All experiments were performed in a nitrogen atmosphere to minimize any degradation of the sample during rheological testing.

### Raw Materials

Raw materials used herein are shown in Table 1, below.

TABLE 1

| Label | Composition | Grade Name | Available from |
|---|---|---|---|
| MCN1 | dimethylsilylbis(tetrahydroindenyl) | Me₂Si(H₄Ind)₂ZrCl₂ | Albemarle Labs, |
| | zirconium dichloride | | Dundalk, MD |
| S1 | silica support | Davison MS 948 (pore | W. R. Grace, Davison |
| | | volume of 1.65 ml/g | Chemical Division, |
| | | | Houston, TX |
| MAO | Methylalumoxane activator | — | Sigma-Aldrich, |
| | | | St. Louis, MO |
| TMA | Trimethylaluminum scavenger | — | Sigma-Aldrich, |
| | | | St. Louis, MO |
| — | ethoxylated stearyl amine antistat | AS-990 | Witco Chemical |
| | continuity agent | | Company Inc., |
| | | | Woodcliff Lake, NJ |

### Catalyst Preparation

The catalyst used in each polymerization was a silica-supported metallocene catalyst. The metallocene was dimethylsilylbis(tetrahydroindenyl) zirconium dichloride (Me₂Si(H₄Ind)₂ZrCl₂). Methylalumoxane (“MAO”) was the activator/cocatalyst. The preparation of the catalyst followed the procedure as described in U.S. Pat. No. 6,476,171, incorporated herein by reference for all purposes. A solution of 1125 ml of 30 wt. % MAO in toluene as determined is by reference to the total aluminum content which may include unhydrolyzed trimethylaluminum (“TMA”) was charged to a two gallon (7.57 liter), jacketed glass-walled reactor, equipped with a helical ribbon blender and an auger-type shaft. 1800 ml of toluene was 30 added and stirred. A suspension of 30.8 g MCN1 in 320 ml of toluene was cannulated into the reactor. An additional 150 ml of toluene was used to rinse solid metallocene crystals into the reactor by cannula under nitrogen pressure. A color change from colorless to yellow/orange was noted upon addition of the metallocene to the MAO solution. The mixture was allowed to stir at 69° F. (20.6° C.) for one hour, before being transferred to a four-liter Erlenmeyer flask under nitrogen. 899 g of Si was charged to the reactor. Half of the solution from the 4 l Erlenmeyer flask was then transferred back to the 2 gallon (7.57 liter) stirred glass reactor. The reaction temperature rose from 70° F. (21.1° C.) to 100° F. (37.8° C.) in a five minute exotherm. The balance of the solution in the 4 liter Erlenmeyer was subsequently added back to the glass reactor, and stirred twenty minutes. Then, toluene was added (273 ml, 238 g) to dilute the active catalyst slurry, and stirred an additional twenty-five minutes. Antistat AS-990 was cannulated to the reactor and the slurry mixed for thirty minutes. Removal of solvent commenced by reducing pressure to less than 18.10 inches of mercury (457 mm Hg) while feeding a small stream of nitrogen into the bottom of the reactor and raising the temperature from 74° F. (23.3° C.) to 142° F. (61.1° C.) over a period of one hour. Then nine and a half additional hours of drying at 142° F. (61.1° C.) to 152° F. (66.7° C.) at a vacuum which ranged from 5 inches to 22 inches Hg (177 to 559 mm Hg) were used to dry the support and yield 1291.4 g of free-flowing active supported catalyst material.

### Polymer Preparation

The polymerization was conducted in a continuous gas phase fluidized bed reactor. The fluidized bed was made up of polymer granules. The gaseous feed streams of ethylene and hydrogen together with liquid comonomer were mixed together in a mixing tee arrangement and introduced below the reactor bed into the recycle gas line. The ICA (specified in the table below for each example) was added with the ethylene and hydrogen and also introduced below the reactor bed into the recycle gas line. The individual flow rates of ethylene, hydrogen and comonomer were controlled to maintain fixed composition targets. The ethylene concentration was controlled to maintain a constant ethylene partial pressure. The hydrogen was controlled to maintain a constant hydrogen to ethylene mole ratio. The concentration of all the gases were measured by an on-line gas chromatograph to ensure relatively constant composition in the recycle gas stream.

The solid catalyst was injected directly into the fluidized bed using purified nitrogen as a carrier. Its rate of injection was adjusted to maintain a constant production rate of the polymer. The reacting bed of growing polymer particles is maintained in a fluidized state by the continuous flow of the make-up feed and recycle gas through the reaction zone. A superficial gas velocity of 1-3 ft/sec (0.3 to 0.9 m/sec) was used to achieve this. The reactor was operated at a total pressure of about 300 psig (2068 kPa gauge). To maintain a constant reactor temperature, the temperature of the recycle gas is continuously adjusted up or down to accommodate any changes in the rate of heat generation due to the polymerization.

The fluidized bed was maintained at a constant height by withdrawing a portion of the bed at a rate equal to the rate of formation of particulate product. The product was removed semi-continuously via a series of valves into a fixed volume chamber, which was simultaneously vented back to the reactor. This allowed for highly efficient removal of the product, while at the same time recycling a large portion of the unreacted gases back to the reactor. This product was purged to remove entrained hydrocarbons and treated with a small stream of humidified nitrogen to deactivate any trace quantities of residual catalyst and cocatalyst. The target conditions for the polymerization process in each example are shown in Table 2.

Inventive Examples I-1 through I-4 were produced in dry mode gas phase polymerization. Comparative Examples C-5 through C-8 were produced in condensed mode gas phase polymerization. Inventive Examples I-1 through 1-3 and comparative Examples C-5 and C-7 each have a melt index I₂ near 0.2 g/10 min. Inventive Example I-4 and comparative Examples I-6 and I-8 each have a melt index I₂ near 0.5 g/10 min.

TABLE 2

| | Examples | | | | | | | |
|---|---|---|---|---|---|---|---|---|
| Process Parameter | I-1 | I-2 | I-3 | I-4 | C-5 | C-6 | C-7 | C-8 |
| Ethylene conc. (mole %) | 60 | 60 | 60 | 60 | 62 | 62 | 62 | 62 |
| Ethylene partial pressure | 183/1.26 | 183/1.26 | 183/1.26 | 183/1.26 | 190/1.31 | 190/1.31 | 190/1.31 | 190/1.31 |
| (psi/MPa) | | | | | | | | |
| H₂ conc. (ppm) | 626 | 644 | 636 | 769 | 786 | 966 | 750 | 914 |
| Flow ratio (kg C₆=/kg C₂=) | 0.096 | 0.112 | 0.106 | 0.104 | 0.122 | 0.127 | 0.089 | 0.098 |
| ICA conc. (molc %) | <5 | <5 | <5 | <5 | 11.9 | 11.6 | 14.5 | 13.7 |
| Reactor bed temp. (° C.) | 179 | 179 | 168 | 179 | 178 | 176 | 183 | 181 |
| Reactor pressure | 290/2.00 | 290/2.00 | 290/2.00 | 290/2.00 | 290/2.00 | 290/2.00 | 290/2.00 | 290/2.00 |
| (psig/MPag) | | | | | | | | |

* ICA for the Inventive cases targeted for zero but may have contained trace amounts.

Table 3 shows the polymer characterization data for the ethylene-hexene copolymers produced in Examples I-3 through I-4 and C-5 through C-8

TABLE 3

| | Examples | | | | | | | |
|---|---|---|---|---|---|---|---|---|
| Resin Parameter | I-1 | I-2 | I-3 | I-4 | C-5 | C-6 | C-7 | C-8 |
| MI, I_{2.16} (g/10 min.) | 0.23 | 0.23 | 0.23 | 0.57 | 0.21 | 0.48 | 0.185 | 0.546 |
| MI, I_{21.6} (g/10 min.) | 10.68 | 10.57 | 9.02 | 21.34 | 8.45 | 15.85 | 8.66 | 19.58 |
| MIR (I_{21.6}/I_{2.16}) | 46.4 | 46 | 39.2 | 37.4 | 40.2 | 33 | 46.8 | 35.9 |
| Density, ρ (g/cc) | 0.9129 | 0.9101 | 0.909 | 0.913 | 0.9111 | 0.9118 | 0.9166 | 0.917 |
| Reactor Temp. (° F.) | 179 | 179 | 168 | 179 | 176 | 176 | 183 | 181 |
| Mw (g/mol) (IR) | 123,730 | 124,863 | 129,057 | 103,691 | 129,356 | 110,089 | 130,600 | 103,357 |
| Mz (g/mol) (IR) | 245,300 | 247,915 | 249,049 | 204,117 | 257,287 | 215,806 | 268,138 | 209,264 |
| Mₙ (g/mol) (IR) | 37,010 | 38,036 | 38,682 | 31,370 | 40,127 | 33,908 | 37,291 | 29,743 |
| Comon. content, | 9.49 | 10.63 | 11.07 | 10.19 | 9.72 | 10.05 | 7.35 | 7.85 |
| Cₙ (wt %) | | | | | | | | |
| SCB content | 15.82 | 17.72 | 18.45 | 16.98 | 16.20 | 16.75 | 12.25 | 13.08 |
| (SCB/1000 C) | | | | | | | | |
| M_{w}/Mₙ Ratio | 3.34 | 3.28 | 3.34 | 3.31 | 3.22 | 3.25 | 3.50 | 3.48 |
| M_{z}/M_{w} Ratio | 1.98 | 1.99 | 1.93 | 1.97 | 1.99 | 1.96 | 2.05 | 2.02 |
| M_{z}/Mₙ Ratio | 6.63 | 6.52 | 6.44 | 6.51 | 6.41 | 6.36 | 7.19 | 7.04 |
| g′ LCB (Vis. Avg.) | 0.95 | 0.943 | 0.955 | 0.954 | 0.98 | 0.963 | 0.962 | 0.971 |

Table 4 shows the M_{w}-specific SCB-SI CCDI for the ethylene-hexene copolymers produced in Examples I-1 through I-4 and C-5 through C-8.

TABLE 4

| | Examples | | | | | | | |
|---|---|---|---|---|---|---|---|---|
| Resin Parameter | I-1 | I-2 | I-3 | I-4 | C-5 | C-6 | C-7 | C-8 |
| Log MW low limit | 4.00 | 4.00 | 4.00 | 4.00 | 4.00 | 4.00 | 4.00 | 4.00 |
| Log MW high limit | 5.50 | 5.50 | 5.50 | 5.50 | 5.50 | 5.50 | 5.50 | 5.50 |
| CC @ log MW low | 6.91 | 8.03 | 7.30 | 7.76 | 8.91 | 8.46 | 6.09 | 6.70 |
| limit (wt %) | | | | | | | | |
| CC @ log MW high | 9.75 | 11.05 | 11.68 | 10.70 | 9.68 | 10.29 | 7.54 | 8.00 |
| limit (wt %) | | | | | | | | |
| #SCB/1000 C @ log | 11.52 | 13.38 | 12.17 | 12.93 | 14.85 | 14.10 | 10.15 | 11.17 |
| MW low limit | | | | | | | | |
| #SCB/1000 C @ log | 16.25 | 18.41 | 19.47 | 17.83 | 16.13 | 17.15 | 12.57 | 13.33 |
| MW high limit | | | | | | | | |
| Mw-Specific SCB-SI | 3.15 | 3.35 | 4.87 | 3.26 | 0.86 | 2.03 | 1.61 | 1.44 |
| CCDI | | | | | | | | |

Table 5 shows the 5-95 SCB-SI CCDI or the ethylene-hexene copolymers produced in Examples I-1 through I-4 and C-5 through C-8.

TABLE 5

| | Examples | | | | | | | |
|---|---|---|---|---|---|---|---|---|
| Resin Parameter | I-1 | I-2 | I-3 | I-4 | C-5 | C-6 | C-7 | C-8 |
| Log MW 5% | 4.01 | 4.03 | 4.03 | 3.93 | 4.05 | 3.97 | 4.02 | 3.9 |
| Log MW 95% | 5.56 | 5.57 | 5.57 | 5.48 | 5.58 | 5.51 | 5.60 | 6.44 |
| CC @ log MW 5% | 7.00 | 8.03 | 7.30 | 7.76 | 8.91 | 8.46 | 6.09 | 6.70 |
| (wt %) | | | | | | | | |
| CC @ log MW 95% | 9.80 | 11.05 | 11.68 | 10.70 | 9.68 | 10.29 | 7.46 | 8.04 |
| (wt %) | | | | | | | | |
| #SCB/1000 C @ log | 11.67 | 13.38 | 12.17 | 12.93 | 14.85 | 14.10 | 10.15 | 11.17 |
| MW low limit | | | | | | | | |
| #SCB/1000 C @ log | 16.33 | 18.41 | 19.47 | 17.83 | 16.13 | 17.15 | 12.43 | 13.40 |
| MW high limit | | | | | | | | |
| 5-95 SCB-SI CCDI | 3.01 | 3.25 | 4.72 | 3.17 | 0.84 | 1.99 | 1.45 | 0.88 |

Table 6 shows the Mₙ-M_{z} SCB-SI CCDI for the ethylene-hexene copolymers produced in Examples I-1 through I-4 and C-5 through C-8.

TABLE 6

| | Examples | | | | | | | |
|---|---|---|---|---|---|---|---|---|
| Resin Parameter | I-1 | I-2 | 1-3 | I-4 | C-5 | C-6 | C-7 | C-8 |
| Log Mₙ | 4.56 | 4.58 | 4.58 | 4.49 | 4.60 | 4.53 | 4.57 | 4.47 |
| Log M_{z} | 5.38 | 5.39 | 5.39 | 5.30 | 5.41 | 5.33 | 5.43 | 5.32 |
| CC @ log Mₙ (wt %) | 8.20 | 9.12 | 8.47 | 8.30 | 9.33 | 9.14 | 6.77 | 7.05 |
| CC @ log M_{z} (wt %) | 9.89 | 11.12 | 11.60 | 10.61 | 9.80 | 10.22 | 7.41 | 8.1 |
| # SCB/1000 C @ log | 13.67 | 15.20 | 14.12 | 13.83 | 15.55 | 15.23 | 11.28 | 11.75 |
| MW low limit | | | | | | | | |
| # SCB/1000 C @ log | 16.48 | 18.53 | 19.33 | 17.68 | 16.33 | 17.03 | 12.35 | 13.50 |
| MW high limit | | | | | | | | |
| Mₙ-M_{z} SCB-SI CCDI | 3.43 | 4.11 | 6.45 | 4.73 | 0.97 | 2.24 | 1.25 | 2.07 |

As shown in Table 3, Examples I-1 through-I-3, C-5, and C-7, all having a melt index 12 of about 0.2 g/10 min., show that dry mode and condensed mode produced polyethylene copolymers having a different molecular architecture. Inventive Examples I-1 through I-3 have a slightly lower branching index g′ᵥᵢₛ than comparative Examples C-5 and C7. This shows that the polyethylene copolymers produced in dry mode have a slightly higher degree of long-chain branching than the polyethylene copolymer produced in the condensed mode.

Examples I-4, C-6, and C-8 show the same trend for polyethylene copolymers having a melt index I₂ of about 0.5 g/10 min. Inventive Example I-4 has a slightly lower branching index g′ᵥᵢₛ than comparative Examples C-6 and C-8. This shows that the polyethylene copolymers having a higher melt index produced in dry mode have a slightly higher degree of long-chain branching than the polyethylene copolymer produced in the condensed mode.

Table 3 also shows that Examples I-1 through I-4 have MIR values within the limitation is of MIR greater than or equal to (46.9−(33.3×I₂)) and/or narrower limitations for MIR disclosed herein. Comparative Examples C-5 and C-6 do not simultaneously meet the broadest MIR limitation in combination with the claimed range for branching index g′ᵥᵢₛ and further fall outside the narrower disclosed MIR limitations. Tables 4-6 furthermore highlight the distinct comonomer distribution, with the preferential incorporation of comonomers on mid- and high-molecular weight chains apparent in the dry-mode inventive examples, having much higher CCDI no matter which of the various endpoints are used in the calculation, as compared to the comparative (condensed-mode) examples.

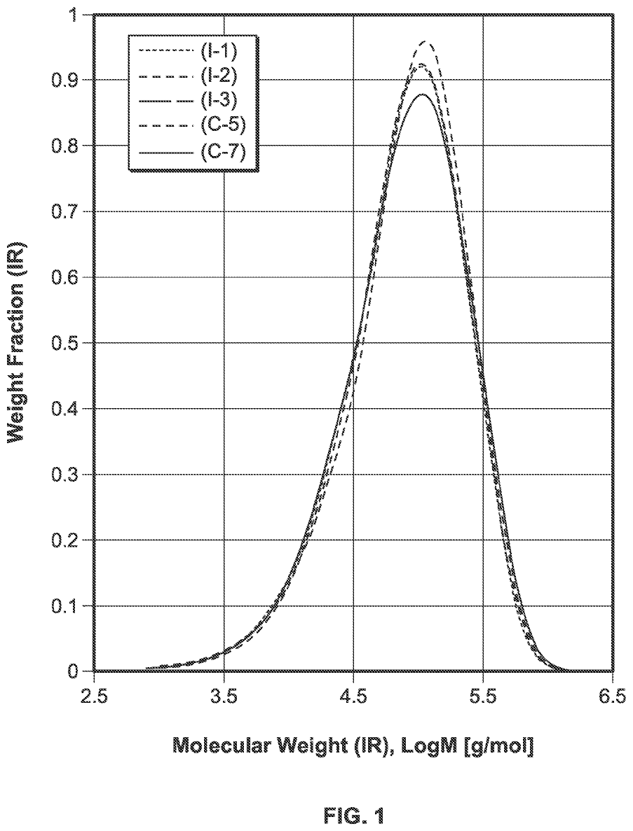

FIG. 1 shows Gel Permeation Chromatography (“GPC”) traces (IR detector) comparing the molecular weight distribution (“MWD”) of inventive Examples I-1 through I-3 to comparative Example C-5. Examples I-1 through I-3 and C-5 are ethylene-hexene copolymers having a melt index 12 of approximately 0.2 g/10 min. This shows that MWD is substantially equivalent for inventive and comparative examples whether produced in the dry mode or the condensed mode.

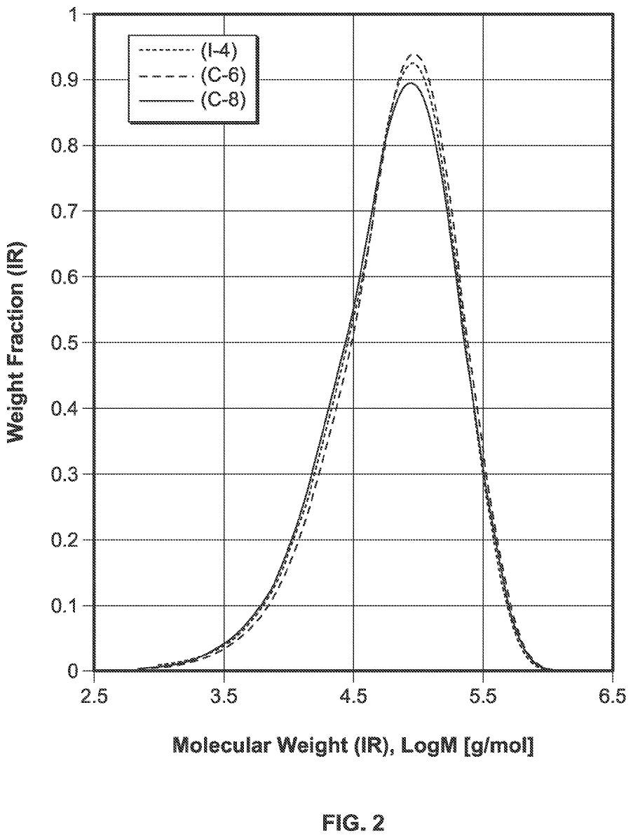

FIG. 2 shows GPC traces comparing the molecular weight distribution (“MWD”) of inventive Example I-4 to comparative Example C-6. Examples I-4 and C-6 are ethylene-hexene copolymers having a melt index I₂ of approximately 0.5 g/10 min. This shows that MWD is substantially equivalent for inventive and comparative examples whether produced in the dry mode or the condensed mode.

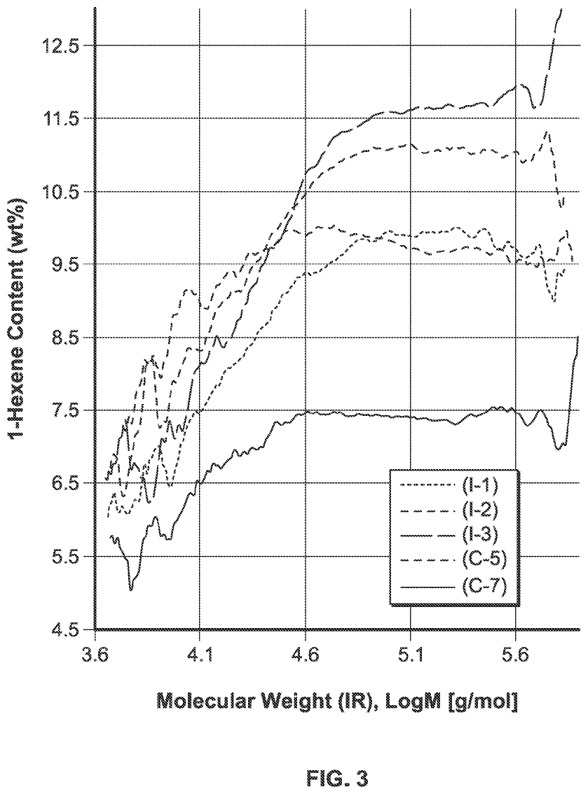

FIG. 3 shows overlaid graphs of comonomer distribution vs. molecular weight for inventive Examples I-1 through I-3 and comparative Examples C-5 and C-7. Similar to Tables 4-6, this shows that inventive Examples I-1 through I-3, produced in the dry mode, have higher weight percent comonomer for higher molecular weight polymer chains (e.g., log M_{w} greater than about 5) than comparative Examples C-5 and C-7. FIG. 3 further shows that inventive Examples I-1 through I-3, produced in the dry mode, have a lower weight percent comonomer for lower is molecular weight polymer chains (e.g., log M_{w} less than about 4.5) than comparative Examples C- and C-7. This again reinforces what is illustrated by the calculated values of M_{w}-specific SCB-SI CCDI as shown in Table 4, 5-95 SCB-SI CCDI as shown in Table 5, and Mₙ-M_{z} CCDI as shown in Table 6, wherein a larger positive CCDI indicates more short-chain branching on higher molecular weight molecules.

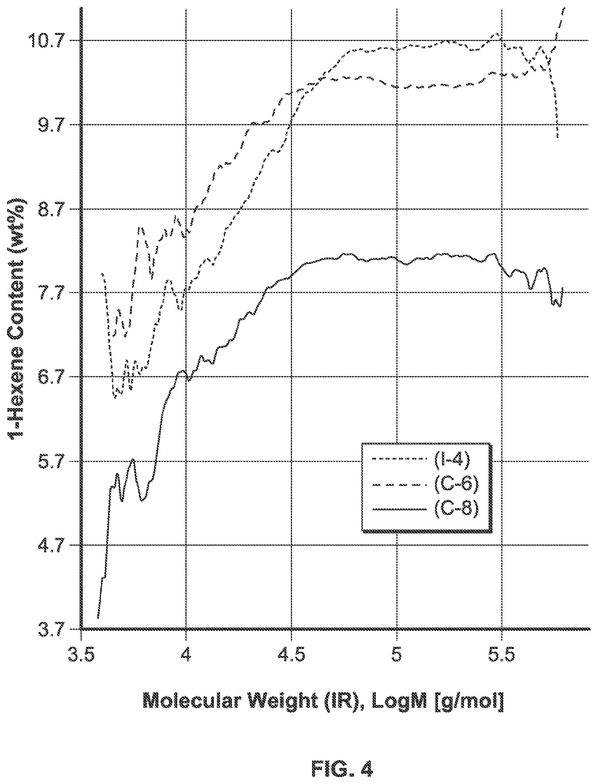

FIG. 4 shows overlaid graphs of comonomer distribution vs. molecular weight for Examples I-4, C-6, and C-8. This likewise shows that inventive Example I-4, produced in the dry mode, has a higher weight percent comonomer for higher molecular weight polymer chains (e.g., log M_{w} greater than about 5) than comparative Example C-6. FIG. 4 further shows that inventive Example 5, produced in the dry mode, has a lower weight percent comonomer for lower molecular weight polymer chains (e.g., log M_{w} less than about 4.5) than comparative Example 6. This, again, is further illustrated by the calculated values of M_{w}-specific SCB-SI CCDI as shown in Table 4, 5-95 SCB-SI CCDI as shown in Table 5, and Mₙ-M_{z} CCDI as shown in Table 6, wherein a larger positive CCDI indicates more short-chain branching on higher molecular weight molecules.

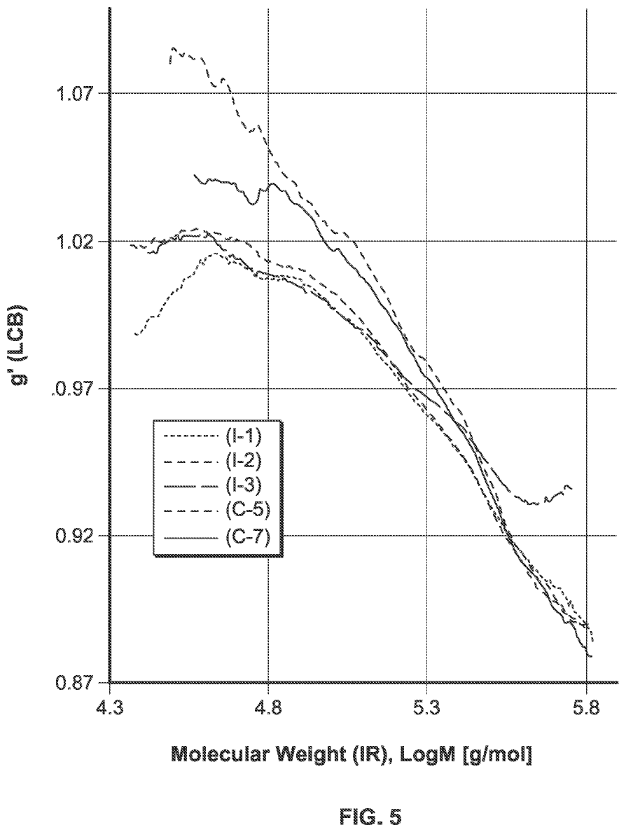

FIG. 5 shows overlaid graphs of branching index (g′) vs. a limited range of molecular weight for inventive Examples I-1 through I-3 and comparative Examples C-5 and C-7. Although the lines for the inventive Examples I-1 through I-3 are difficult to differentiate, FIG. 5 does show that the g′ᵥᵢₛ lines for Examples I-1 through I-3 below the line for comparative Examples C-5 and C-7.

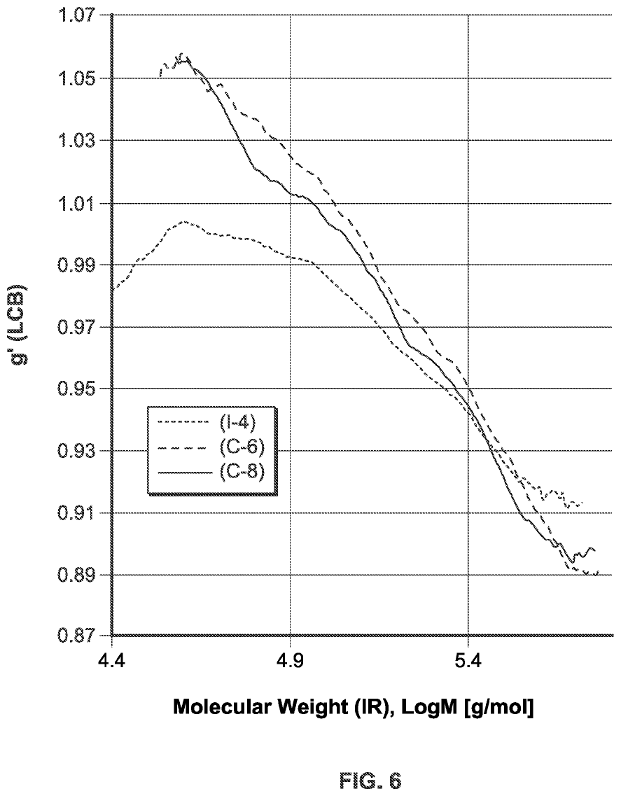

FIG. 6 shows overlaid graphs of branching index (g′) vs. a limited range of molecular weight for inventive Example I-4 and comparative Examples C-6 and C-8. Although the lines for the inventive Examples I-1 through I-3 are difficult to differentiate, FIG. 6 does show that the g′ᵥᵢₛ lines for Example I-4 is below the line for comparative Examples C-6 and C-8.

### Film Preparation

Film samples were prepared by extruding 1 mil (25.4 μm) monolayer films on an Alpine 2 blown film line. Blown film evaluations of the polymers were carried out on an Alpine blown film line equipped with a 160 mm monolayer die having a 30 mil (762 μm) die gap and a 2.5:1 BUR. Extrusion rate was 300 lb/hr (136 kg/hr).

Table 7 shows the improved processability of inventive Examples I-1 through I-4 achieved through a reduction in melt viscosity. Comparing the average values of Examples I-1 through I-3 to Example C-5, polyethylene copolymers disclosed herein, produced in a dry mode is gas phase polymerization show a 12% reduction in motor load, a 6% decrease in melt pressure before screen pack, and an 11% decrease in melt pressure after screen pack for melt index I₂ values of about 0.20 g/10 min. Although comparative Example C-7 shows comparable processability to inventive Examples I-1 through I-3, it has a higher density, indicating lower toughness, and a higher g′ᵥᵢₛ, indicating less overall long-chain branching. Additionally, Tables 4-6 show that CCDI is higher for inventive Examples I-1 through I-3 in contrast to comparative Examples C-5 and C-7.

Comparing the average values of inventive Example 1-4 to comparative Examples C-6 and C-8, polyethylene copolymers disclosed herein, produced in a dry mode gas phase polymerization show a 10% reduction in motor load, a 8% decrease in melt pressure before screen pack, and an 11% decrease in melt pressure after screen pack for melt index I₂ values of about 0.50 g/10 min. In addition to poorer processability than inventive Example I-4, comparative Example C-8 also has a higher density, indicating lower toughness, and a higher g′ᵥᵢₛ, indicating less overall long-chain branching. Additionally, Tables 4-6 show that CCDI is higher for inventive Example I-4 in contrast to comparative Examples C-6 and C-8.

TABLE 7

| Film Fabrication | Examples | | | | | | | |
|---|---|---|---|---|---|---|---|---|
| Parameter | I-1 | I-2 | I-3 | I-4 | C-5 | C-6 | C-7 | C-8 |
| Motor load (ampere) | 55.1 | 53.1 | 52.1 | 49.4 | 60.4 | 54.9 | 53.3 | 52.9 |
| Melt pressure (before | 7998 | 7928 | 8074 | 6325 | 8538 | 6849 | 7901 | 6256 |
| screen pack) (psig) | | | | | | | | |
| Melt pressure (before | 55.1 | 54.7 | 55.7 | 43.6 | 58.9 | 47.2 | 54.4 | 43.1 |
| screen pack) (MPa-g) | | | | | | | | |
| Melt pressure (after screen | 6426 | 6287 | 6557 | 5111 | 7242 | 5708 | 6410 | 5181 |
| pack) (psig) | | | | | | | | |
| Melt pressure (after screen | 44.3 | 43.3 | 45.2 | 35.2 | 49.9 | 39.4 | 44.1 | 35.7 |
| pack) (MPa-g) | | | | | | | | |

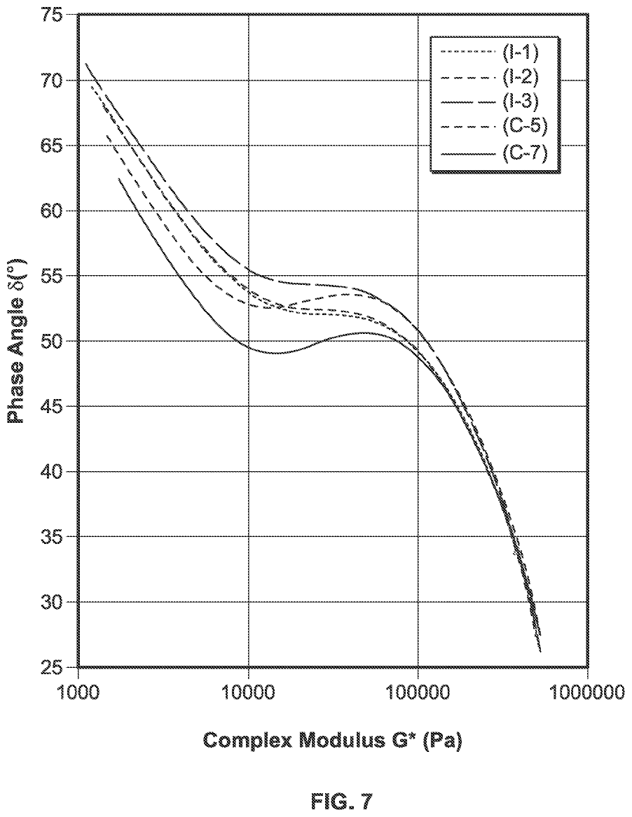

FIG. 7 shows overlaid graphs of Van Gurp-Palmen plots of phase angle (δ) vs. complex modulus for Examples I-1, I-2, and C-5. The overlaid graphs provide a comparison of inventive Examples I-1 and I-2 to comparative Example C-5. The left portion of the graph lines for the inventive Examples I-1 and I-2 are below that of the graph line for comparative Example C-5. The right portion of the graph lines for the inventive Examples I-1 and I-2 are below that of the graph line for comparative Example C-5. While both the inventive and the comparable samples exhibit similar phase angle values (δ) at low complex modulus (G*), the phase angle values for the inventive cases exhibit a sharper decay compared to the comparables along with increase in G* before plateauing. These differences suggest slightly more long-chain branching in the inventive examples. This would offer the greater bubble stability and improved processability during the film blowing process.

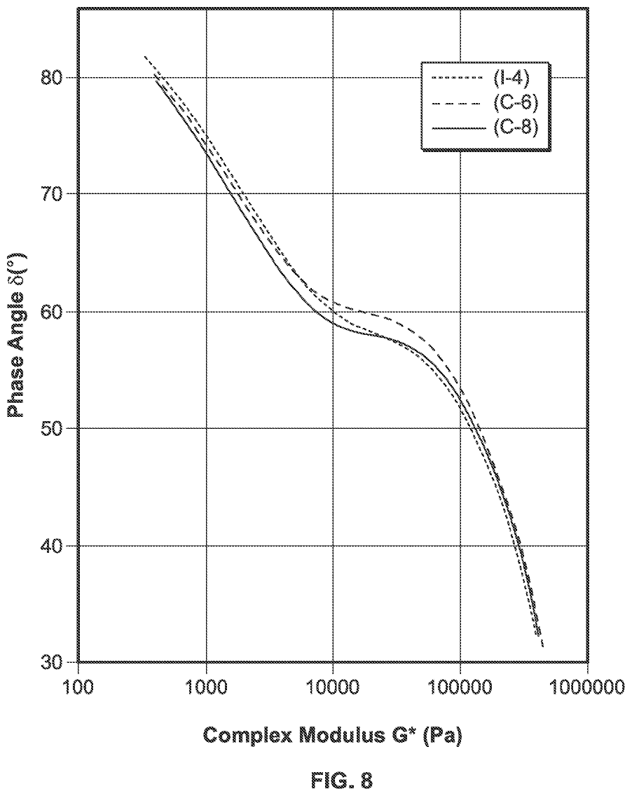

FIG. 8 shows overlaid graphs of van Gurp-Palmen plots of phase angle (δ) vs. complex modulus for Examples I-4 and C-6. The overlaid graphs provide a comparison of inventive Example I-4 to comparative Example C-6. The left portion of the graph lines for the inventive Example I-4 are below that of the graph line for comparative Example C-6. The right portion of the graph lines for inventive Example I-4 is below that of the graph line for comparative Example C-6. While both the inventive and the comparable samples exhibit similar phase angle values (δ) at low complex modulus (G*), the phase angle values for the inventive cases exhibit a sharper decay compared to the comparables along with increase in G* before plateauing. These differences suggest slightly more long-chain branching in the inventive examples. This would offer the greater bubble stability and improved processability during the film blowing process.

The subtle differences in molecular architecture have a tangible effect on extrudability during the blown film fabrication process as shown in Table 4. It should be noted that while the MIR of the polymers is affected by the reactor temperature (see Tables 2 and 3), the samples produced in the dry mode consistently demonstrate superior extrudability over the samples produced in the condensed mode, thus allowing the end user to potentially run at higher output rates and/or lower energy consumption.

Although the present invention and its advantages have been described in detail, it should be understood that various changes, substitutions and alterations can be made herein without departing from the spirit and scope of the invention as defined by the appended claims. Ranges for various characteristics and attributes disclosed herein are listed as sequentially narrowing ranges. However, it should be understood that any lower endpoint of any ranges can be paired with any upper endpoint for the same characteristic or attribute, and such pairings are also intended to be disclosed herein. All patents, test procedures, and other documents cited in this application are fully incorporated herein by reference for all jurisdictions in which such incorporation is permitted. Moreover, the scope of the present application is not intended to be limited to the particular embodiments of the processes, machines, film structures, composition of layers, means, methods, and/or steps described in the specification. As one of the ordinary skill in the art will readily appreciate from the disclosure of the present invention, processes, machines, film structures, composition of layers, means, methods, and/or steps, presently existing or later to be developed that perform substantially the same function or achieve substantially the same result as the corresponding embodiments described herein, may be utilized according to the present invention. Accordingly, the appended claims are intended to include within their scope such processes, machines, film structures, composition of layers, means, methods, and/or steps.

What is claimed is:

1. A polyethylene copolymer, comprising ethylene-derived units and units derived from at least one olefin comonomer having 4 to 8 carbon atoms, and having:
a) a density in the range of from 0.908 g/cm³ to 0.916 g/cm³;
b) a melt index I₂ in the range of from 0.10 g/10 min. to 0.60 g/10 min.; and
c) a melt index ratio I₂₁/I₂ of greater than or equal to 46.9−(33.3×(I₂)), wherein I₂ is provided in g/10 min.

2. The polyethylene copolymer of claim 1, wherein the melt index ratio I₂₁/I₂ is greater than or equal to 55.1−(33.3×(I₂)).

3. The polyethylene copolymer of claim 1, further having a branching index g′ᵥᵢₛ in the range of from 0.940 to 0.960.

4. The polyethylene copolymer of claim 1, further having a density in the range of
((0.0025×W)+(0.0056×*I₂)+0.9353) g/cm³±0.001 g/cm³, wherein W is the weight percent comonomer incorporated into the polyethylene copolymer.

5. The polyethylene copolymer of claim 1, wherein the at least one olefin comonomer is butene, hexene, or a combination thereof, and further wherein the comonomer content of the polyethylene copolymer is within the range from 9.0 wt % to 11.0 wt %.

6. The polyethylene copolymer of claim 1, further having one or more of the following:
a) a weight average molecular weight M_{w} in the range of
$$( ( 2 , 900 \times W ) - ( 63 , 500 \times {I}_{2} ) + 110 , 300 ) g / mol \pm 2 , 000 g / mol ;$$
b) a Z-average molecular weight M_{z} in the range of
$$( ( 2 , 360 \times W ) - ( 125 , 900 \times {I}_{2} ) + 252 , 000 ) g / mol \pm 1 , 000 g / mol ;$$
and
c) a number average molecular weight Mₙ in the range of
$$( ( 1 , 027 \times W ) - ( 18 , 620 \times {I}_{2} ) + 31 , 500 ) g / mol \pm 500 g / mol .$$

7. The polyethylene copolymer of claim 6, further having one or more of:
a) a molecular weight distribution M_{w}/Mₙ in the range of from 3.27 to 3.46;
b) a molecular weight distribution M_{z}/M_{w} less than or equal to 2.0; and
c) a molecular weight distribution M_{z}/Mₙ in the range of from 6.42 to 6.95.

8. The polyethylene copolymer of claim 1, further having:
a) a composition distribution breadth index (“CDBI”) greater than or equal to 85%;
b) a short-chain branch sloe index chemical composition distribution index (“SCB-SI CCDI”) greater than or equal to 3.0; or
c) a combination thereof.

9. The polyethylene copolymer of claim 1, further having:
a) a gloss at 45° of greater than or equal to (33.67+(46.67× (I₂))) GU;
b) a haze of less than or equal to (20.47−(10.33×(I₂)))%; or
c) a combination thereof.

10. The polyethylene copolymer of claim 1, wherein the at least one comonomer is hexene, the polyethylene copolymer having:
a) a melt index I₂ in the range of 0.10 g/10 min. to 0.30 g/10 min.; and
b) a melt index ratio I₂/I₂ of greater than or equal to 45.1.

11. The polyethylene copolymer of claim 1, wherein the at least one comonomer is hexene, the polyethylene copolymer having:
a) a melt index I₂ in the range of 0.40 g/10 min. to 0.60/10 min.; and
b) a melt index ratio I₂₁/I₂ of greater than or equal to 35.1.

12. A continuous gas phase process for the production of a polyethylene copolymer, the process comprising
a) continuously passing a gaseous stream, comprising ethylene and at least one olefin comonomer having from 4 to 8 carbon atoms, through a fluidized bed reactor in the presence of a metallocene catalyst under polymerization conditions, wherein polymerization conditions comprise an ethylene partial pressure greater than or equal to 600 kPa and a reactor pressure of less than or equal to 10,000 kPa;
b) withdrawing the polyethylene copolymer and a stream comprising unreacted ethylene, unreacted comonomer, and optionally an induced condensing agent, wherein the induced condensing agent comprises less than 5 mol % of the stream;
c) cooling the stream, comprising unreacted ethylene, unreacted comonomer, and induced condensing agent, to form a cooled stream, wherein the cooled stream is substantially free of a liquid phase; and
d) feeding the cooled stream to the fluidized bed reactor with sufficient additional ethylene and at least one comonomer to replace the ethylene and the at least one comonomer polymerized and withdrawn as the polyethylene copolymer.

13. The process of claim 12, wherein the metallocene catalyst composition is represented by the formula:
$$( {C}_{5} {R}_{m}^{′} ) {pR}_{s}^{″} ( {C}_{5} {R}_{m}^{′} ) {Q}_{2}$$
wherein:
M is a Group 4, 5, 6 transition metal;
at least one C₅R′ₘ is a substituted cyclopentadienyl;
each R′, which can be the same or different is hydrogen, alkyl, alkenyl, aryl, alkylaryl, or arylalkyl radical having from 1 to 20 carbon atoms or two carbon atoms joined together to form a part of a substituted or unsubstituted ring or rings having 4 to 20 carbon atoms;
R″ is one or more of or a combination of a carbon, a germanium, a silicon, a phosphorous or a nitrogen atom containing radical bridging two (C₅R′ₘ) rings; and
each Q which can be the same or different is an aryl, alkyl, alkenyl, alkylaryl, or arylalkyl radical having from 1 to 20 carbon atoms, halogen, or alkoxides.

14. The process of claim 13, wherein the metallocene catalyst composition is dimethylsilyl-bis-(tetrahydroindenyl) zirconium dichloride (Me₂Si(H₄Ind)₂ZrCl₂).

15. The process of claim 12, wherein the at least one olefin comonomer is butene, hexene, or a combination thereof.

16. The process of claim 12, further comprising one or more of:
a) a reactor bed temperature in the range of from 60° C. to 120° C.;
b) a reactor pressure in the range of from 680 kPag to 3448 kPag;
c) a molar ratio of comonomer to ethylene in the range of from 2% to 6%;
d) a mass flow ratio of comonomer to ethylene in range of from 9.5 kg comonomer/kg ethylene to 12.5 kg comonomer/kg ethylene;
e) an ethylene partial pressure greater than or equal to 1,200 kPaa;
f) an ethylene concentration in the range of from 94.5 mol % to 98.0 mol %;
g) a hydrogen to ethylene ratio of from 5 ppm/mol to 15 ppm/mol; and
h) a hydrogen concentration in the range of from 1 ppm to 2,000 ppm.

17. The process of claim 12, wherein the polyethylene copolymer comprises ethylene-derived units and units derived from at least one olefin comonomer having 4 to 8 carbon atoms, and having:
a) a density in the range of from 0.908 g/cm³ to 0.916 g/cm³
b) a melt index I₂ in the range of from 0.10 g/10 min. to 0.60 g/10 min.;
c) a melt index ratio I₂₁/I₂ of greater than or equal to 46.9−(33.3×(I₂)), wherein I₂ is provided in g/10 min.; and
d) a branching index g′ᵥᵢₛ in the range of from 0.940 to 0.960.

18. The process of claim 17, wherein the at least one comonomer is hexene, the polyethylene copolymer having:
a) a melt index I₂ in the range of 0.10 g/10 min. to 0.30 g/10 min.; and
b) a melt index ratio I₂₁/I₂ of greater than or equal to 45.1.

19. The process of claim 17, wherein the at least one comonomer is hexene, the polyethylene copolymer having:
a) a melt index I₂ in the range of 0.40 g/10 min. to 0.60 g/10 min.; and
b) a melt index ratio I₂₁/I₂ of greater than or equal to 35.1.

20. A polyethylene copolymer produced by the process of claim 13.
